(19) United States
(12) Patent Application Publication
(10) Pub. No.: US 2011/0272290 A1
(43) Pub. Date: Nov. 10, 2011

(54) SYSTEMS AND METHODS FOR ELECTROCHEMICAL ANALYSIS OF ARSENIC

(76) Inventors: Purnendu K. Dasgupta, Arlington, TX (US); Mrinal K. Sengupta, Fremont, CA (US)

(21) Appl. No.: 13/079,746

(22) Filed: Apr. 4, 2011

Related U.S. Application Data
(60) Provisional application No. 61/320,392, filed on Apr. 2, 2010.
(60) Provisional application No. 61/412,543, filed on Nov. 11, 2010.

(51) Int. Cl. C25B 1/00; C25B 9/04; G01N 27/26

(52) U.S. Cl. 205/335; 205/775; 205/477; 204/230.5; 204/400

(57) ABSTRACT

Embodiments of methods for electrochemical analysis of arsenic are described. In one embodiment, a method includes detecting arsenic (III) by, at least in part, applying electrolytic current to an arsenic compound that has not been reduced with a reducing agent. In another embodiment, a method for electrochemical analysis of arsenic includes detecting arsenic (V) by, at least in part, applying electrolytic current to an arsenic compound that has not been reduced with a reducing agent.

### CROSS REFERENCE TO RELATED APPLICATIONS

This application claims priority to U.S. Provisional Patent Application No. 61/320,392, filed Apr. 2, 2010, and U.S. Provisional Patent Application No. 61/412,543, filed Nov. 11, 2010, both of which are incorporated by reference in their entireties.

### STATEMENT REGARDING FEDERALLY SPONSORED RESEARCH

This invention was made with government support under grant number CHE-0709994 awarded by the National Science Foundation. The government has certain rights in the invention.

### BACKGROUND OF THE INVENTION

1. Field of the Invention

This invention relates to analyzing arsenic and more particularly relates to systems and methods for electrochemical analysis of arsenic.

2. Description of the Related Art

Arsenic and its various species have had a long and paradoxical interaction with mankind. To one extent it has been extensively used in tracking gold mines, semiconductor chips, paint, pesticides, wood preservative, drugs and in certain chemotherapeutic treatment, but on the other end their poisonous properties have caused misery and many deaths over the ages. For around the last half a century, concern has centered on the naturally occurring high concentrations of inorganic arsenic that contaminates drinking water; causing chronic poisoning to millions of people worldwide leading to cancer and non-cancerous effects and creating a global panic. Exposure to elevated levels of arsenic, a class I human carcinogen, has become a global concern, affecting millions worldwide. The currently recommended upper limit of arsenic in drinking water is 10 μg/L. Temporal and seasonal changes in arsenic in South Asian well-water are well documented, necessitating frequent measurement.

Even at high concentrations arsenic in water is colorless, tasteless, and odorless. Therefore a determination based on bulk physical properties is not feasible and one must rely on instrumental analysis. Measuring the total arsenic provides only an overall contamination scenario, and the bioavailability, physiological and toxicological effects of As could be better understood from its chemical form. The success of a given removal strategy depends on precisely what form the arsenic is present in. Inorganic, rather than organic, arsenic is prevalent in the drinking water and exists in two forms: arsenite [As(III)] and arsenate [As(V)]. The two greatly differ in their toxicity and are the species of interest. There is a plethora of detection techniques in the extant literature focusing on the speciation of As(III) and As(V) in drinking water, but a reliable, standalone fieldable analyzer is yet to be developed.

Most existing separation techniques are based on chromatographic approaches coupled with an element specific detector like an atomic or plasma source mass spectrometer. While chromatographic methods are highly selective in species selection, their operating protocols often are complex, require greater analysis time, and do not lend themselves to fieldable instrumentation. On the other hand, the non-chromatographic techniques, such as, solvent extraction, solid phase extraction (SPE), co-precipitation, capillary micro extraction (CME), and cloud point extraction (CPE), are simple and less time consuming, though the operational costs are higher once they are coupled with the sophisticated laboratory-based detectors.

### SUMMARY OF THE INVENTION

Embodiments of methods for electrochemical analysis of arsenic are presented. In one embodiment, a method includes detecting arsenic (III) by, at least in part, applying electrolytic current to an arsenic compound that has not been reduced with a reducing agent.

In one embodiment, a method of electrochemical analysis of arsenic includes detecting arsenic (V) by, at least in part, applying electrolytic current to an arsenic compound that has not been reduced with a reducing agent.

In one embodiment, a method of electrochemical analysis of arsenic includes generating arsine by, at least in part, applying current to a graphite cathode, the graphite cathode being in contact with an arsenic compound through an electrolyte. In one embodiment, the electrolyte is Sulfuric Acid (H₂SO₄).

In a further embodiment, the method may include mixing the arsine with ozone gas. The method may also include detecting a level of chemiluminescence generated by a reaction between the arsine and the ozone gas.

In one embodiment, a method may include detecting total arsenic in a sample by, at least in part, applying current at a first level to an electrode in contact with a first portion of the sample. Such an embodiment may also include detecting arsenic (III) in the sample by, at least in part, applying current at a second level to an electrode in contact with a second portion of the sample. In this embodiment, the first level may be greater than the second level.

For example, in one embodiment, the arsenic compound may be arsenic (III). The method may include applying 0.1 Amps of current to the graphite cathode to generate the arsine from arsenic (III). In another embodiment, the target arsenic compound may include arsenic (V). Such an embodiment may include applying 0.8 Amps of current to the graphite cathode to generate the arsine from both arsenic (III) and arsenic (V).

In one embodiment a method may include detecting total arsenic in a sample by, at least in part, applying current at a first level to an electrode in contact with a first portion of the sample. This method may also include determining an amount of arsenic (V) in the sample using the total arsenic. In such an embodiment, the level of arsenic (V) may be determined through calculating a difference between the level of total arsenic in the sample and the level of arsenic (III) in the sample.

Embodiments of an apparatus are also described. In one embodiment, the apparatus may include an electrochemical reactor that includes a graphite cathode. The apparatus may also include a current source connected to the graphite cathode, the current source configured to deliver one of two different current levels to the graphite cathode. In one embodiment the apparatus may also include a driver configured to drive the current source at one of the two different current levels. One of ordinary skill in the art will recognize various current source and driver configurations that are suitable for use with the present embodiments. For example, the driver may include a hardware circuit configured to switch (e.g., automatically) between two current levels. In another embodiment, the driver may include external user controls. In still another embodiment, the driver may include a software program configured to be executed on a processor or microcontroller.

In an embodiment, the apparatus may also include a chemiluminescence reaction chamber coupled to the electrochemical reactor. The apparatus may also include chemiluminescence detector coupled to the chemiluminescence reaction chamber, and configured to detect a chemiluminescence level caused by a reaction in the chemiluminescence reaction chamber. In a further embodiment, the apparatus may also include an ozone generator coupled to the chemiluminescence reaction chamber and configured to supply ozone to the chemiluminescence reaction chamber for mixing with the arsine. The ozone generator may be coupled to the electrochemical reactor and configured to receive oxygen molecules generated during the electrochemical reaction. The apparatus may also include a gas/liquid separator coupled to the electrochemical reactor and configured to separate arsine from a product of the electrochemical reactor.

In one embodiment, the apparatus may also include an arsenic oxidation unit coupled to the electrochemical reactor, the arsenic oxidation unit configured to oxidize total arsenic to arsenic (V). In such an embodiment, the arsenic oxidation unit may use sodium hypochlorite (NaOCl) as an oxidizing agent to convert arsenic (e.g., all arsenic) to arsenic (V) during use. One of ordinary skill in the art will recognize that certain embodiments described herein may be configured for use with an oxidation unit, but an oxidation unit may not be required for any particular embodiment. The description of the oxidation unit is merely intended as an illustration of an example in which the present embodiments may be extended for use with additional systems and components.

The term “coupled” is defined as connected, although not necessarily directly, and not necessarily mechanically.

The terms “a” and “an” are defined as one or more unless this disclosure explicitly requires otherwise.

The term “substantially” and its variations are defined as being largely but not necessarily wholly what is specified as understood by one of ordinary skill in the art, and in one non-limiting embodiment “substantially” refers to ranges within 10%, preferably within 5%, more preferably within 1%, and most preferably within 0.5% of what is specified. In any embodiment of the present disclosure, the term “substantially” may be substituted with “within [a percentage] of” what is specified, where the percentage includes 5, 10, and/or 15 percent.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or apparatus (also characterizable as a system) that “comprises,” “has,” “includes” or “contains” one or more steps or elements possesses those one or more steps or elements, but is not limited to possessing only those one or more elements Likewise, a step of a method or an element of an apparatus that “comprises,” “has,” “includes” or “contains” one or more features possesses those one or more features, but is not limited to possessing only those one or more features. Furthermore, an apparatus or structure that is configured in a certain way is configured in at least that way, but may also be configured in ways that are not listed.

Other features and associated advantages will become apparent with reference to the following detailed description of specific embodiments in connection with the accompanying drawings.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented below.

FIG. 1 is a schematic block diagram illustrating one embodiment of an apparatus for electrochemical analysis of arsenic.

FIG. 2 is a schematic diagram illustrating one embodiment of an apparatus for electrochemical analysis of arsenic.

FIG. 3 is a graphical diagram illustrating chemiluminescence signals detected from a known sample of 50 μg/L As(III) and 50 μg/L As(V) on different cathode materials relative to the response of 50 μg/L As(III) on a Pt cathode taken as unity.

FIG. 4 is a graphical diagram illustrating reproducibility of selected cathode materials for electrochemical arsine generation (EAG) from 50 μg/L As(III).

FIG. 5 is a schematic block diagram illustrating one embodiment of an apparatus for electrochemical analysis of arsenic.

FIG. 6 is a schematic block diagram illustrating one embodiment of an apparatus for electrochemical analysis of arsenic.

FIG. 7 is a schematic diagram of one embodiment of an apparatus for electrochemical analysis of arsenic.

FIG. 8 is a schematic diagram of one embodiment of an electrochemical reactor (ECR).

FIG. 9 is a schematic diagram illustrating one embodiment of a gas-liquid separator.

FIG. 10 is a schematic flowchart diagram illustrating one embodiment of a method for electrochemical analysis of arsenic.

FIG. 11 is a schematic block diagram illustrating one embodiment of an apparatus for electrochemical analysis of arsenic.

FIG. 12 is a schematic block diagram illustrating one embodiment of an apparatus for electrochemical analysis of arsenic.

FIG. 13 is a schematic block diagram illustrating one embodiment of an arsine hydride generator.

FIG. 14 is a graphical diagram illustrating a response for catholyte and anolyte concentration at 50 μg/L As(III) (solid line), and As(V) (dotted line) operated at a constant current 1.0 A and 1 cm² cathode surface area.

FIG. 15 is a graphical diagram illustrating a response of 50 μg/L As(III) and As(V) at different anolyte (0.1 M H₂SO₄).

FIG. 16 is a graphical diagram illustrating a chemiluminescence signal detecting As(III) and As(V) with respect to the current density on a cathode.

FIG. 17 is a graphical diagram illustrating the effect of ozone flow rate into the chemiluminescence reaction chamber.

FIGS. 18A-18B are graphical diagrams illustrating a linear relationship between the applied voltage and the current for different cathode areas and a dynamic cell resistance according to one embodiment of the described apparatuses.

FIG. 19 is a graphical diagram illustrating a response at different concentrations of As(III) and As(V); 0.1/0.5 M H₂SO₄ anolyte/catholyte.

FIG. 20 is a graphical diagram illustrating a calibration curve for As(III) and As(V) using a oxygen feed ozone generation system.

FIG. 21 is a graphical diagram illustrating a response of As(V) and As(III) after online addition of NaOCl. 0.1/0.5 M H₂SO₄ anolyte/catholyte.

FIG. 22 is a graphical diagram illustrating a calibration curve depicting the responses of As(III), As(V) and As(V) after reduction to As(III) using KI and ascorbic acid. 0.1/0.5 M H₂SO₄ anolyte/catholyte.

FIG. 23 is a graphical diagram illustrating a calibration curve showing no difference in sensitivity between As(V) and As(III) after addition of NaOCl to sample.

FIG. 24 is a graphical diagram illustrating a calibration curve for As(V) showing higher response with a oxygen feed ozone generation system compared to air feed ozone generation system.

FIG. 25 is a graphical diagram illustrating a comparison of the total As measured using induction coupled plasma-mass spectrometry (ICP-MS) and the present system.

FIG. 26 is a graphical diagram illustrating a comparison between two chemical arsine generation-gas phase chemiluminescence (GPCL) methods with an embodiment of a method for measuring total As in tap water and spiked tap water samples.

FIG. 27 is a graphical diagram illustrating analytical results for water samples as measured with an embodiment of a method for electrochemical analysis of arsenic as compared with other techniques.

FIG. 28 is a graphical diagram illustrating a response of As(III) and As(V) with different electrochemical reactor size.

FIG. 29 is a graphical diagram illustrating a response of As(III) and As(V) at different electrolyte concentrations.

FIG. 30 is a graphical diagram illustrating a response of As(III) and As(V) at different electrolyte flow rates.

FIG. 31 is a graphical diagram illustrating a response of As(III) and As(V) at different operating currents.

FIG. 32 is a graphical diagram illustrating an embodiment of a calibration plot for different concentrations of As(III) and As(V).

FIG. 33 represents analytical results for 26 water samples comparing an embodiment of a method for electrochemical analysis of arsenic with an ICP-MS measurement.

FIG. 34 is a graphical diagram illustrating a response plot for As(III) at different operating currents.

FIG. 35 is a graphical diagram illustrating a response plot for As(V) at different operating currents.

FIG. 36 is a graphical diagram illustrating a response of different gas-liquid separators towards arsine transportation from As(III) and As(V).

FIG. 37 is a graphical diagram illustrating a CF-EAG-GPCL calibration showing a comparison of As(III) and As(V) response at 0.8 A operating current.

FIG. 38 is a graphical diagram illustrating a CF-EAG-GPCL calibration showing response for As(III) only at 0.1 A operating current.

FIG. 39 is a graphical diagram illustrating a comparison of the total As measured using ICP-MS and a continuous flow-electrochemical arsine generator-gas phase chemiluminescence (CF-EAG-GPCL) system.

FIG. 40A is a graphical diagram illustrating a response of As(III) with continuous flow.

FIG. 40B is a graphical diagram illustrating a response of AS (III) after compressing.

### DETAILED DESCRIPTION

Various features and advantageous details are explained more fully with reference to the nonlimiting embodiments that are illustrated in the accompanying drawings and detailed in the following description. Descriptions of well known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure.

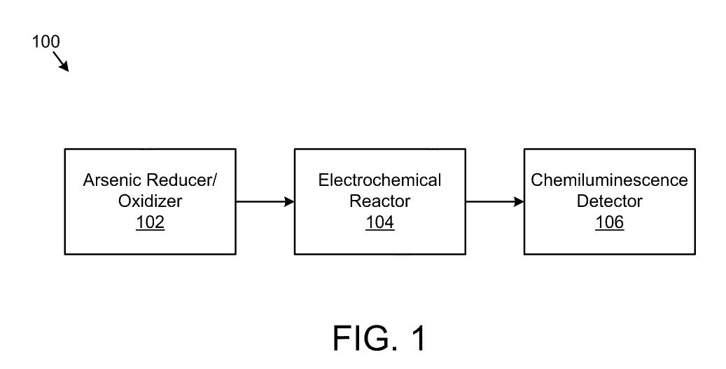

FIG. 1 is a schematic block diagram illustrating one embodiment of an apparatus for electrochemical analysis of arsenic. In one embodiment, the apparatus 100 includes an arsenic reducer/oxidizer unit 102, an electrochemical reactor 104, and a chemiluminescence detector 106. In one embodiment, the apparatus 100 may detect arsenic (III) by, at least in part, applying electrolytic current to an arsenic compound. In another embodiment, the apparatus 100 may detect arsenic (V) by, at least in part, applying electrolytic current to an arsenic compound. In the depicted embodiment, total arsenic may be reduced to either arsenic(III) or oxidized to arsenic (V) in the arsenic reducer/oxidizer unit 102. In other embodiments described below, the apparatus 100 may detect arsenic (III) that has not been reduced with a reducing agent.

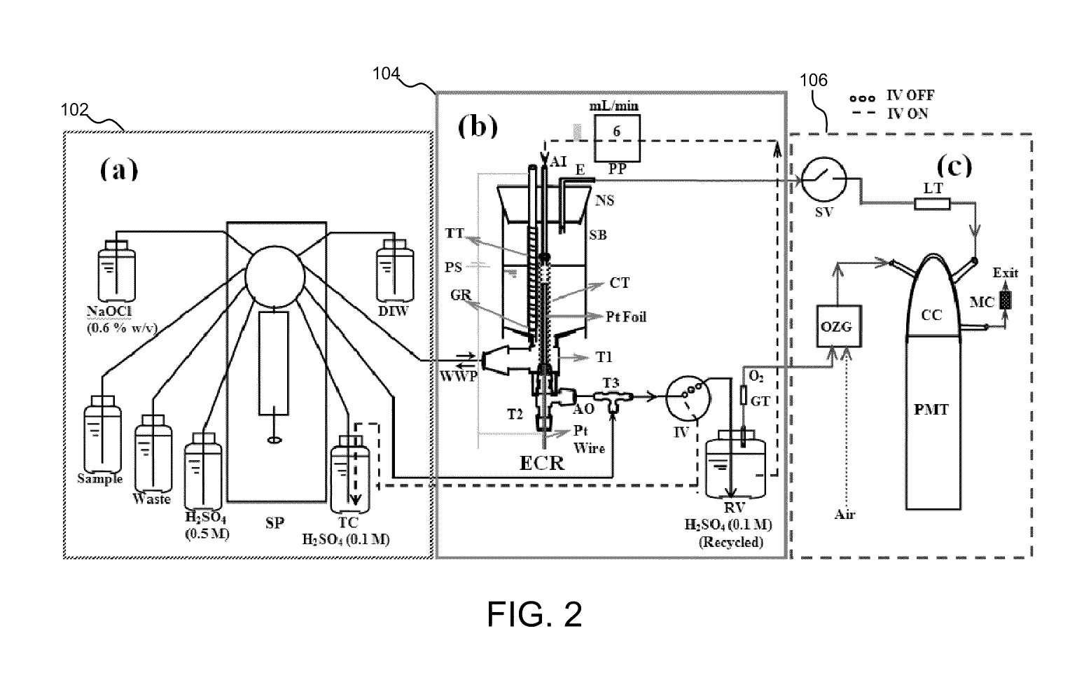

FIG. 2 is a schematic diagram illustrating one embodiment of an apparatus 100 for electrochemical analysis of arsenic that includes an arsenic reducer/oxidizer unit 102. As illustrated in FIG. 2, the apparatus 200 may include additional components, such as pumps, containers, an ozone generator, and the like.

In one embodiment, the arsenic reducer/oxidizer unit 102 may include a liquid handling module that includes syringe pump and multiport distribution valve (SP) and various sample/reagents. The apparatus 200 may also include an electrochemical arsine generation module 104 that includes a disposable syringe barrel (SB) with neoprene stopper (NS) housing a Teflon® tape (TT) wrapped graphite rod (GR), and ceramic tube (CT) that houses Pt foil anode connected via Pt-wire exiting through sealed end of tee T2. One of ordinary skill in the art will recognize a variety of different materials suitable for various components of the electrochemical reactor 104. For example, a glass or polymer tube may be used in place of the disposable syringe. In one embodiment, a power supply (PS) may connected to GR and a Pt anode. In one embodiment, tees, T1 providing waste/wash port WWP and T2 providing anode liquid outlet AO, connect to a 3-way isolation valve IV with tee T3 placed in-between. The solid line of solenoid valve IV may be a common port, configured to be connected to the reservoir vessel (RV) that may act as the analyte and oxygen storage. In one embodiment, when turned on, IV is connected to the container TC. One port of SP may access TC and deliver liquid back to RV via T3. The RV liquid may be recirculated by pump PP through the anode liquid inlet AI connected to CT. Oxygen from RV may exit through glass wool filled liquid trap GT and feed the ozonizer OZG.

In one embodiment, the apparatus 100 may include a gas phase chemiluminescence detection module 106. In such an embodiment, ozone generated by ozone generator (OZG) may flow into the chemiluminescence chamber (CC) while arsine coming from SB via exit tube E enters CC via solenoid valve SV and liquid trap LT. The exit gas flows out of CC through activated Mn oxide catalyst MC. The emitted light may be detected by Photomultiplier tube PMT.

In some embodiments, arsenic reduction/oxidation unit 102 is coupled to the electrochemical reactor 104 and configured to oxidize total arsenic to arsenic (V). In such an embodiment, the arsenic reduction/oxidation unit may use sodium hypochlorite (NaOCl) as an agent to oxidize the total arsenic to arsenic (V) during use. One of ordinary skill in the art will recognize that certain embodiments described herein may be configured for use with reduction/oxidation unit 102, but reduction/oxidation unit 102 may not be required for any particular embodiment. The description of the reduction/oxidation unit 102 is merely intended as an illustration of an example in which the present embodiments may be extended for use with additional systems and components.

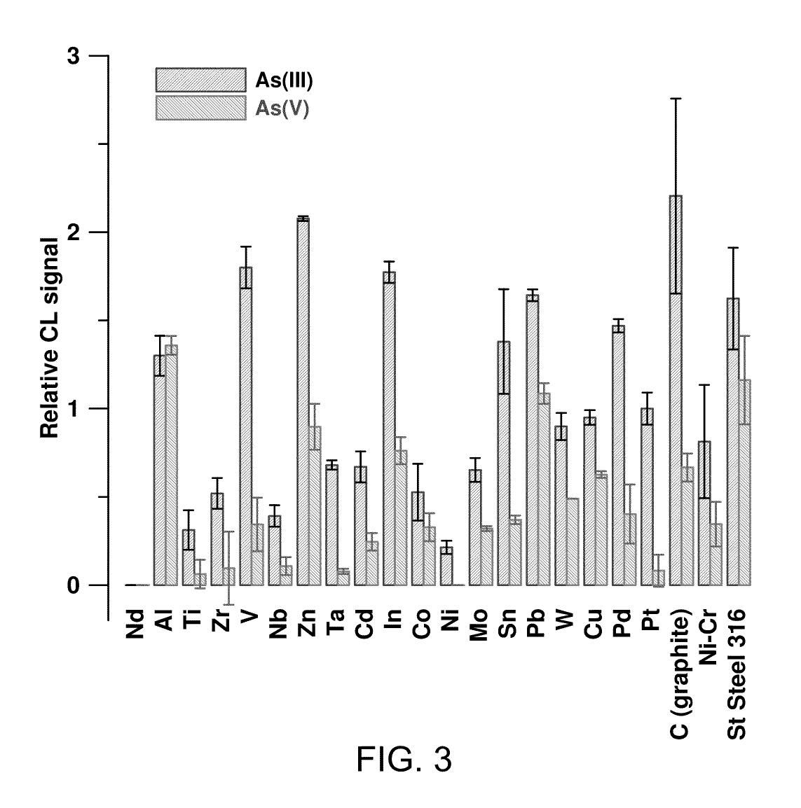

As described above, the electrochemical reactor may include a graphite cathode and a platinum anode. One of ordinary skill in the art will recognize, however, that alternative materials may be suitable for use in an electrochemical reactor. FIG. 3 is a graphical diagram illustrating chemiluminescence signals detected from a known sample of 50 μg/L As(III) and 50 μg/L As(V) on different cathode materials. For simplification, this graph has been normalized, such that the results for each material are relative to the response of 50 μg/L As(III) on a Pt cathode taken as unity. Additionally, metals Nd—Pt are listed in order of their standard reduction potential; carbon, nichrome and stainless steel are listed thereafter. From FIG. 3 it can be seen that graphite provides a very good response; however, other materials may be suitable for use with the present embodiments. The electrodes used should be chosen with due care; for example, the electrodes must not reactively dissolve in the acid to which they are exposed even in the absence of the protective cathodic potential.

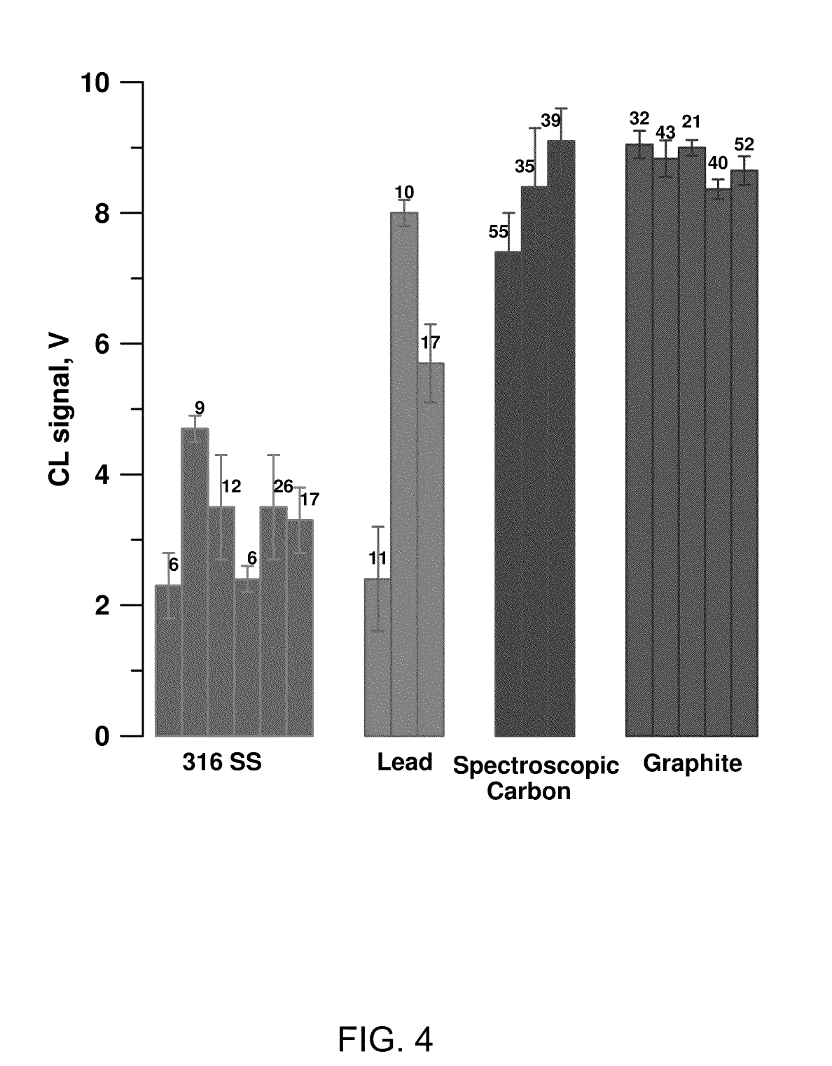

An advantage of using a graphite cathode is reproducibility. FIG. 4 is a graphical diagram illustrating reproducibility of selected cathode materials for EAG from 50 μg/L As(III). In this figure, each bar represents a particular day and the number above the bar indicates the number of measurements made that day. Standard deviation of the measurements over each day is shown as an error bar.

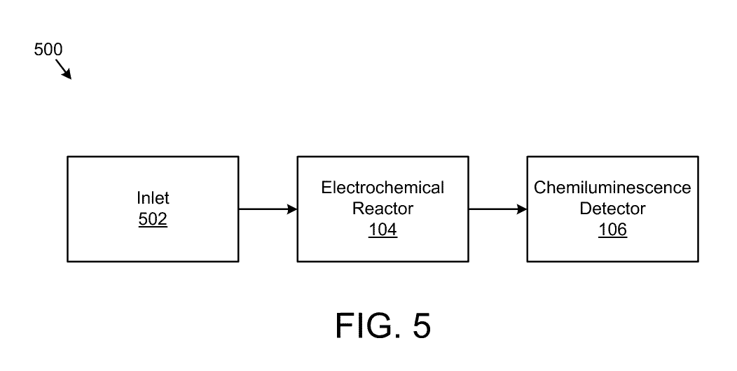

FIG. 5 is a schematic block diagram illustrating another embodiment of an apparatus 500 for electrochemical analysis of arsenic. In this embodiment, the apparatus 500 may include an inlet 502 for receiving a sample containing arsenic. The apparatus 500 may also include an electrochemical reactor 104 and a chemiluminescence detector 106. In such an embodiment, the apparatus 500 may detect arsenic (III) by, at least in part, applying electrolytic current to an arsenic compound that has not been reduced with a reducing agent. Also, the apparatus 500 may detect arsenic (V) by, at least in part, applying electrolytic current to an arsenic compound that has not been reduced with a reducing agent.

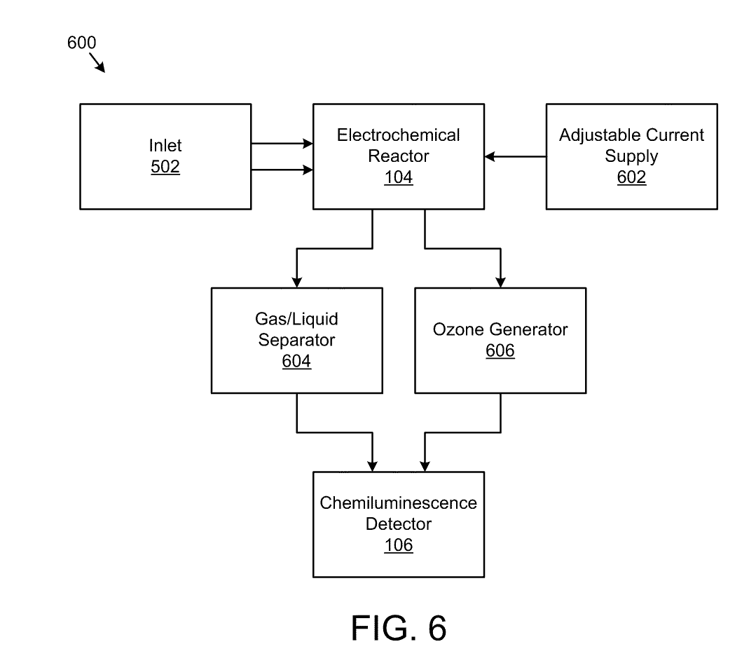

FIG. 6 is a schematic block diagram illustrating another embodiment of an apparatus 600 for electrochemical analysis of arsenic. In this embodiment, the apparatus includes inlet 502, electrochemical reactor 104 and chemiluminescence detector 106. Additionally, apparatus 600 may include an adjustable current supply 602, a gas-liquid separator 604, and an ozone generator 606. In one embodiment, the apparatus 600 may include an electrochemical reactor 104 that includes a graphite cathode. The adjustable current source 502 may be coupled to the electrodes and configured to deliver one of two different current levels through the electrodes, one of which is the graphite cathode. In one embodiment the apparatus 600 may also include a driver configured to drive the current source 602 at one of the two different current levels. One of ordinary skill in the art will recognize various current source and driver configurations that are suitable for use with the present embodiments. For example, the driver may include a hardware circuit configured to switch (e.g., automatically) between two current levels. In another embodiment, the driver may include external user controls. In still another embodiment, the driver may include a software program configured to be executed on a processor or microcontroller.

In one embodiment, electrochemical reactor 104 may generate arsine by, at least in part, applying current to a graphite cathode, the graphite cathode being in contact with an arsenic compound through an electrolyte. In one embodiment, the electrolyte is sulfuric acid (H₂SO₄).

In one embodiment, electrochemical reactor 104 may generate arsine from total arsenic in a sample by, at least in part, applying current at a first level to an electrode in contact with a first portion of the sample. Such an embodiment may also include detecting arsenic (III) in the sample by, at least in part, applying current at a second level to an electrode in contact with a second portion of the sample. In this embodiment, the first level may be greater than the second level, and the electrode may be a graphite cathode.

For example, in one embodiment, the arsenic compound may be arsenic (II). The power supply 602 may apply 0.1 Amps of current to the graphite cathode to generate the arsine from arsenic (III). In another embodiment, the target arsenic compound may include arsenic (V). In such an embodiment the current source 602 may apply 0.8 Amps of current to the graphite cathode to generate the arsine from both arsenic (III) and arsenic (V).

In one embodiment the current source 602 may apply current at a first level to an electrode in contact with a first portion of the sample, and an amount of arsenic (V) in the sample may be determined using the total arsenic.

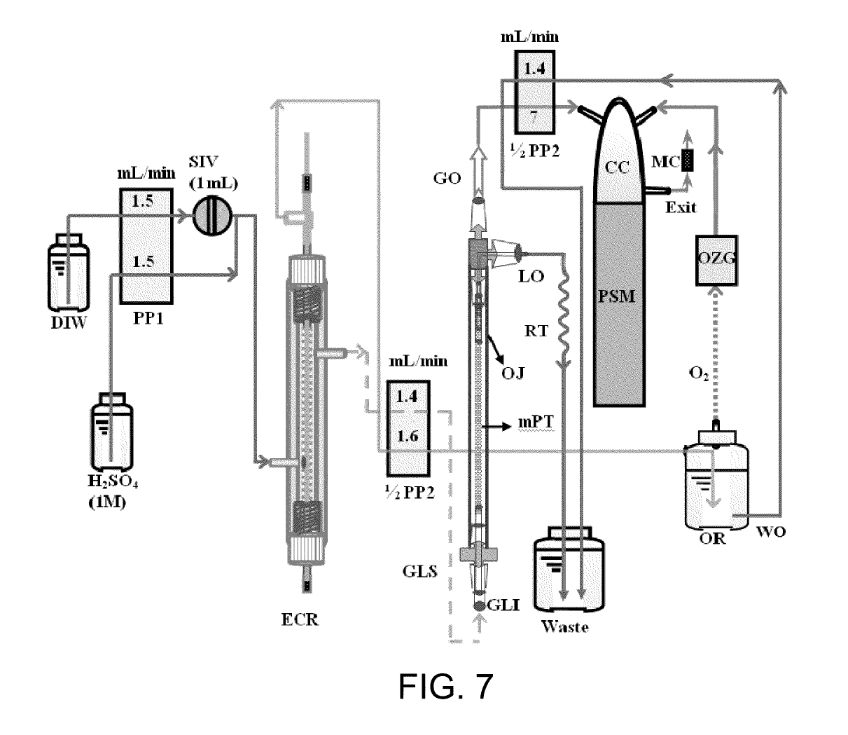

FIG. 7 is a schematic diagram of one embodiment of an apparatus 700 for electrochemical analysis of arsenic. The apparatus 700 may include one or more peristaltic pumps (PP1, PP2), a sample injection valve (SIV), a gas-liquid separator (GLS), a gas-liquid inlet (GLI), micro-porous tube (mPT), an outer jacket (OJ), a liquid outlet (LO), a restriction tube (RT), a gas outlet (GO), an oxygen reservoir (OR), a waste outlet (WO), an ozone generator 606, chemiluminescence chamber (CC), photo sensor module (PSM), and activated Mn oxide catalyst (MC).

As illustrated in this embodiment, the chemiluminescence reaction chamber may be coupled to electrochemical reactor 104. The apparatus 700 may also include chemiluminescence detector 106 coupled to the chemiluminescence reaction chamber, and configured to detect a chemiluminescence level caused by a reaction in the chemiluminescence reaction chamber. In a further embodiment, the apparatus 700 may also include an ozone generator 606 coupled to the chemiluminescence reaction chamber and configured to supply ozone to the chemiluminescence reaction chamber for mixing with the arsine. The ozone generator 606 may be coupled to electrochemical reactor 104 and configured to receive oxygen molecules generated during the electrochemical reaction. Oxygen may also be independently generated by an independent electrolysis apparatus with the sole purpose of generating oxygen. The apparatus 700 may also include a gas/liquid separator 603 coupled to electrochemical reactor 104 and configured to separate arsine from a product of electrochemical reactor 104.

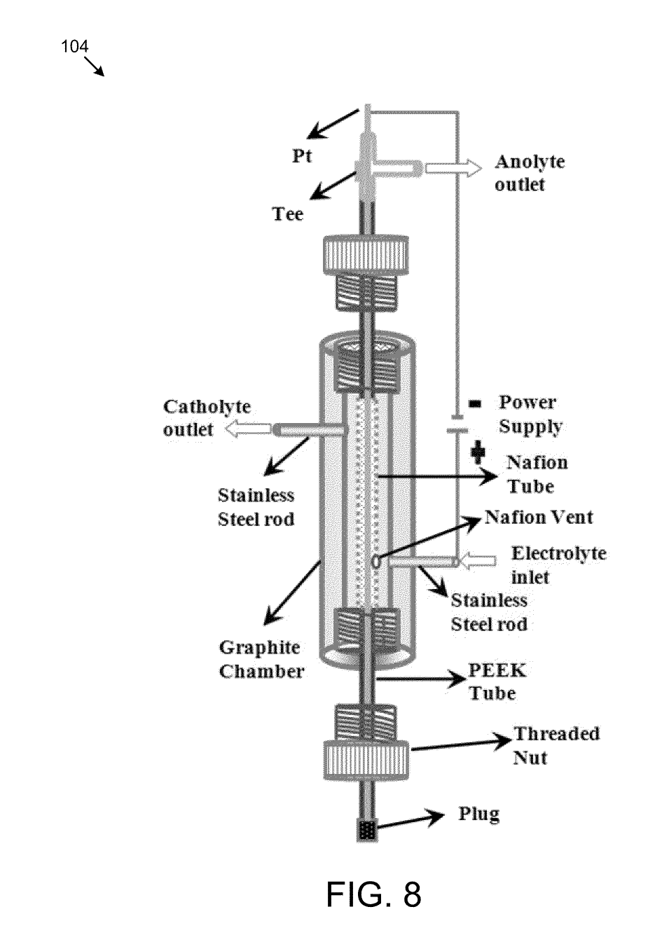

FIG. 8 is a schematic diagram of one embodiment of an electrochemical reactor (ECR) 104. In one embodiment, ECR 104 may include a housing. For example in FIG. 2, the housing is a syringe tube. In another embodiment, the housing may be a glass or plastic tube. The ECR 104 may also include an anode and a cathode. In one embodiment, the cathode may include graphite and the anode may include platinum. The graphite cathode may be a graphite rod or plate. In one embodiment, the cathode may be a graphite rod having an annular shape and a passageway formed through a middle portion of the rod. The anode may run either parallel to the cathode as illustrated in FIG. 2, or through the cathode in concentric fashion as illustrated in FIG. 8. The graphite cathode may be coupled directly to the current source 602 via electrical contacts made of copper, gold, platinum, or other suitable materials. In one embodiment the ECR 104 may include one or more inlets 502 for allowing the sample containing arsenic to contact the graphite cathode. In a further embodiment, the inlet 502 may also receive an electrolyte, such as sulfuric acid, with the sample to facilitate electrical coupling between the sample and the graphite cathode.

In one embodiment, the graphite cathode may receive 0.1 Amps of current from the current source 602. In such an embodiment, the graphite cathode may cause the arsenic(III) in the sample to generate arsine. In another embodiment, the graphite cathode may receive 0.8 Amps of current from the current source 602. In such an embodiment, the graphite cathode may cause the arsenic(III) and the arsenic (V) in the sample to generate arsine. In an alternative embodiment, the current may be 0.85 Amps.

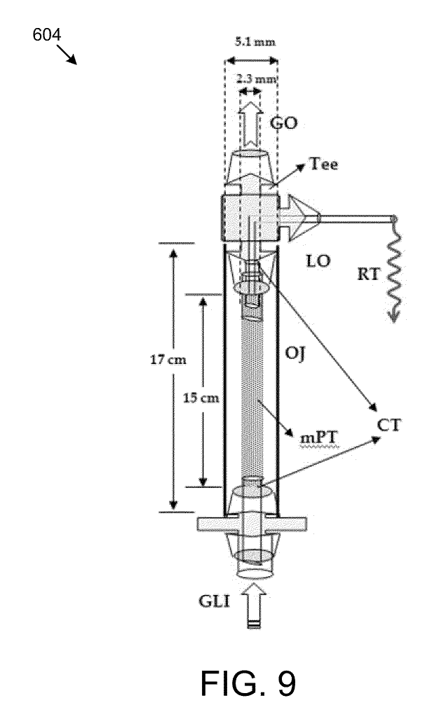

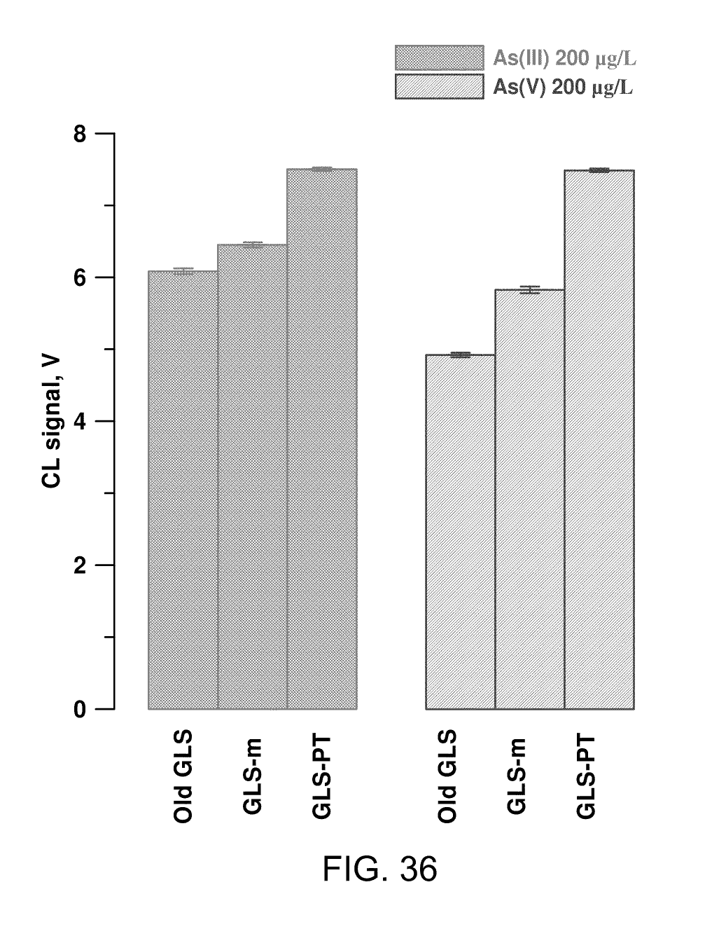

FIG. 9 is a schematic diagram illustrating one embodiment of a gas-liquid separator 604. In a hydride based analysis, gas-liquid separator 604 may separate a higher amount of arsine from the gas-liquid effluent efficiently and reproducibly. Generally, gravity based separators or hydrophobic micro-porous tubular membranes have been adopted for this purpose. Under the inventors' operating conditions, a gas liquid separator made from a micro-porous tubular membrane (GLS-mPT) provided superior performance compared to a glass separator built in the laboratory (GLS-R) and a miniaturized commercially available glass separator (GLS-m) 18 and 14% for As(III) and 34 and 22% for As(V) as depicted in FIG. 36.

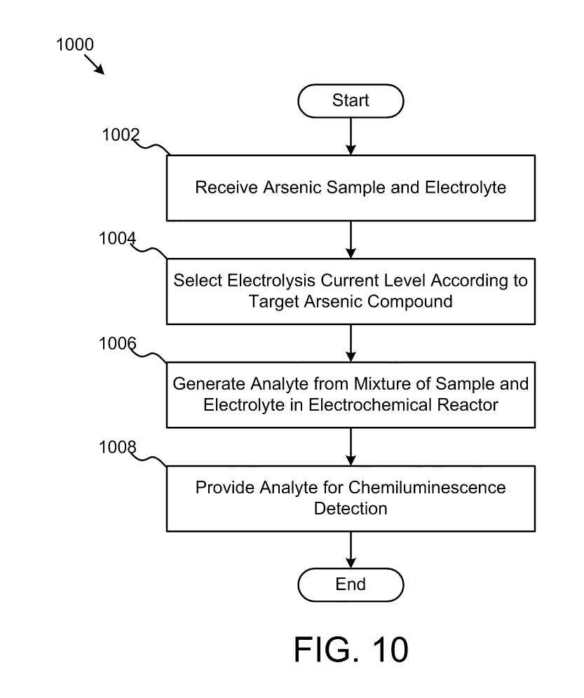

FIG. 10 is a schematic flow chart illustrating one embodiment of a method 1000 for electrochemical analysis of arsenic. Generally, the method 1000 may detect arsenic (III) by, at least in part, applying electrolytic current to an arsenic compound that has not been reduced with a reducing agent. Alternatively, the method 1000 may detect arsenic (V) by, at least in part, applying electrolytic current to an arsenic compound that has not been reduced with a reducing agent.

For example, the method 1000 may include receiving (1002) an arsenic sample and an electrolyte. The method may also include selecting (1004) an electrolysis current level according to a target arsenic compound. For example, the current level may be 0.1 Amps for arsenic(III) or 0.85 for arsenic(III) and (V). The method 1000 may also include generating (1006) analyte from the mixture of the sample and the electrolyte in electrochemical reactor 104. In one embodiment, the analyte is arsine. The method 1000 may also include providing (1008) analyte for chemiluminescence detection. For example, the arsine may mix with ozone generated by the OZG 606 in the chemiluminescence reaction chamber.

In one embodiment, the method of electrochemical analysis of arsenic includes generating arsine by, at least in part, applying current to a graphite cathode, the graphite cathode being in contact with an arsenic compound through an electrolyte. In one embodiment, the electrolyte is sulfuric acid (H₂SO₄).

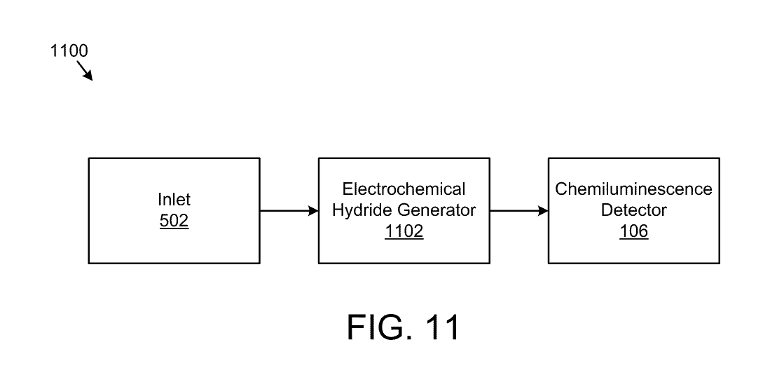

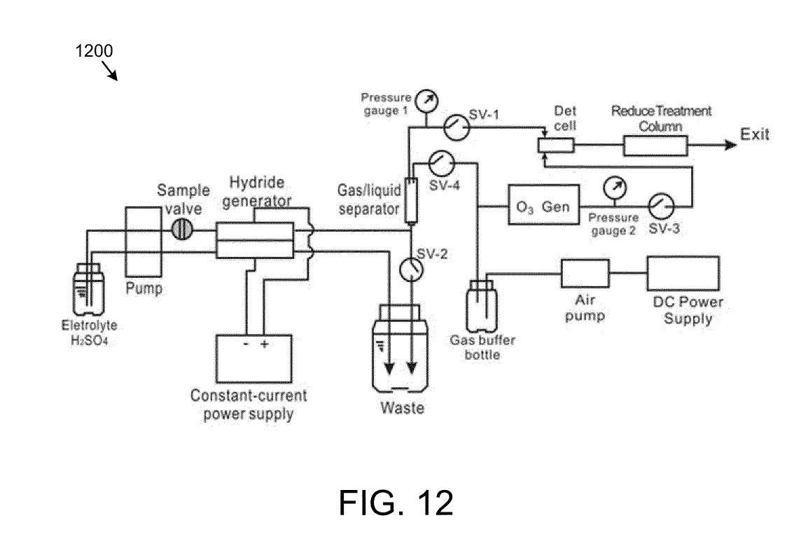

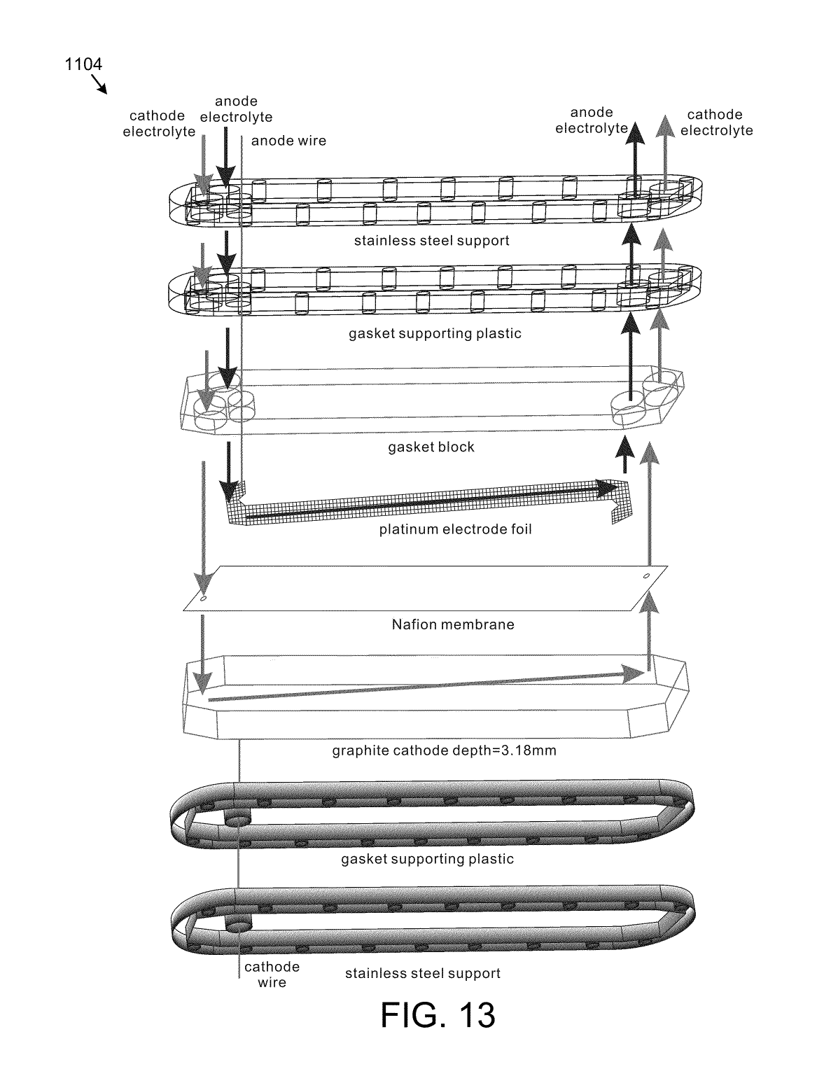

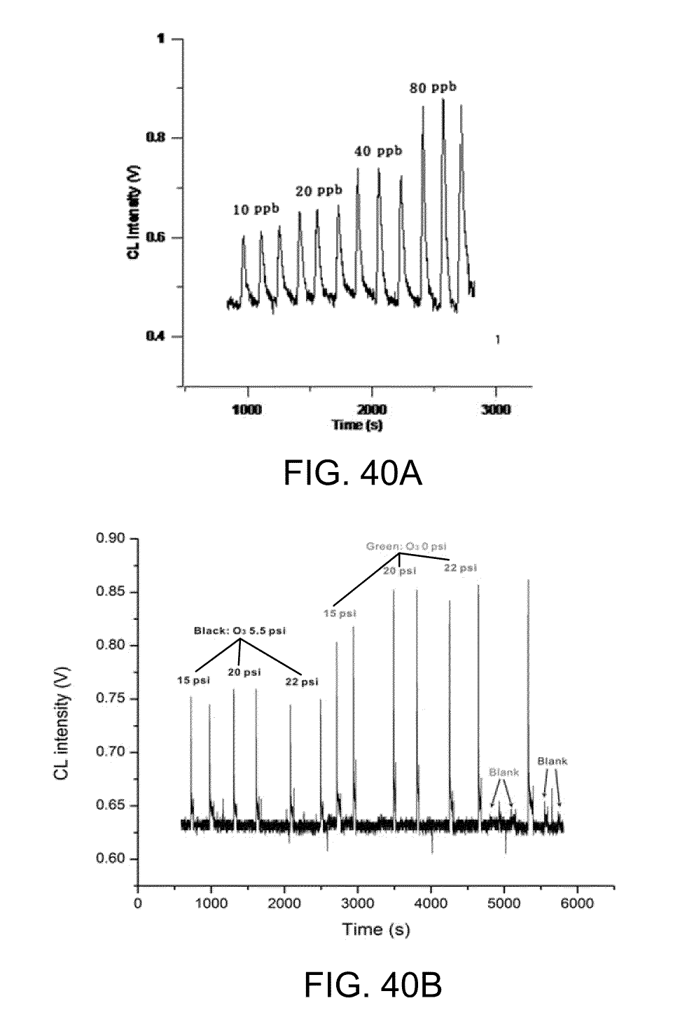

FIG. 11 is a schematic block diagram illustrating one embodiment of an apparatus 1100 for electrochemical analysis of arsenic. In one embodiment, the apparatus 1100 includes inlet 502, electrochemical hydride generator 1102, and chemiluminescence detector 106. A further embodiment of the apparatus is illustrated in FIG. 12. Such an embodiment may be configured for continuous flow operation. In certain embodiments, the electrochemical hydride generator 1102 may include a graphite cathode as illustrated in FIG. 13. Such an embodiment of apparatus 1100 may be capable of high sensitivity measurements of arsenic compounds at lower ppb levels than other systems. Sample results of tests performed using apparatus 1100 are illustrated in FIGS. 40A-B.

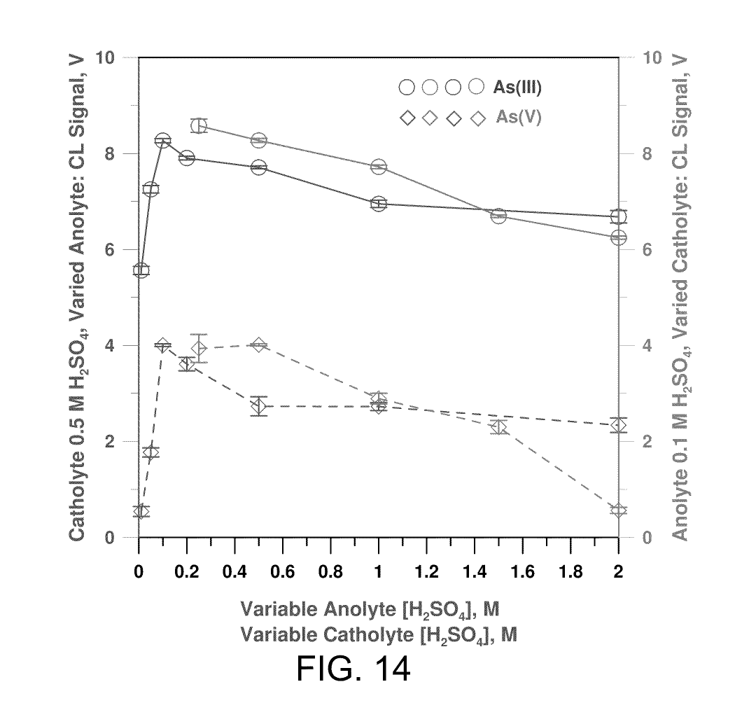

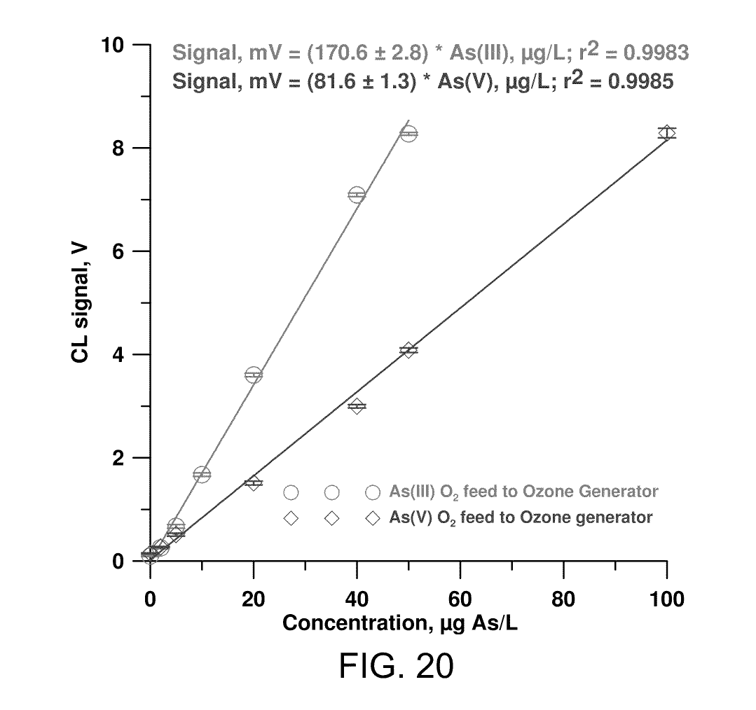

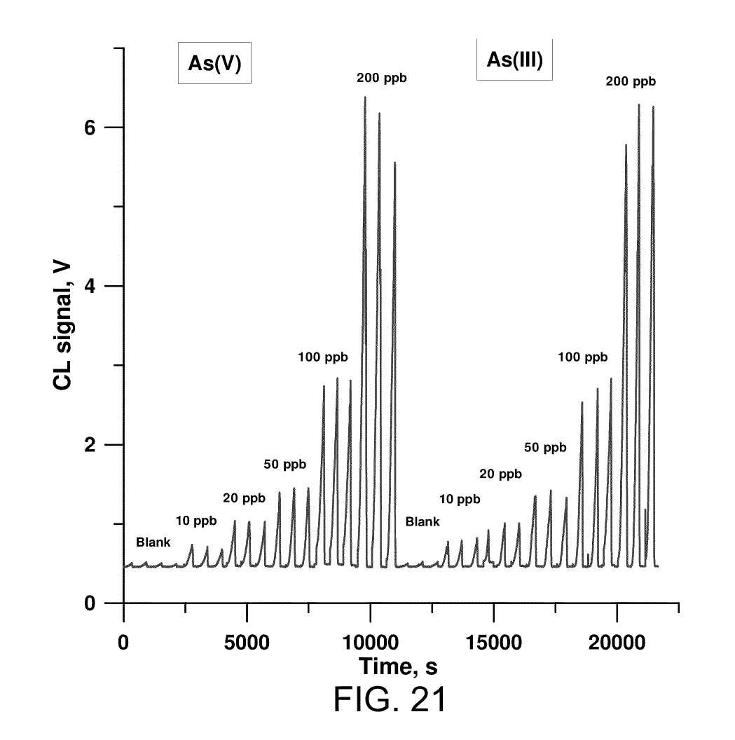

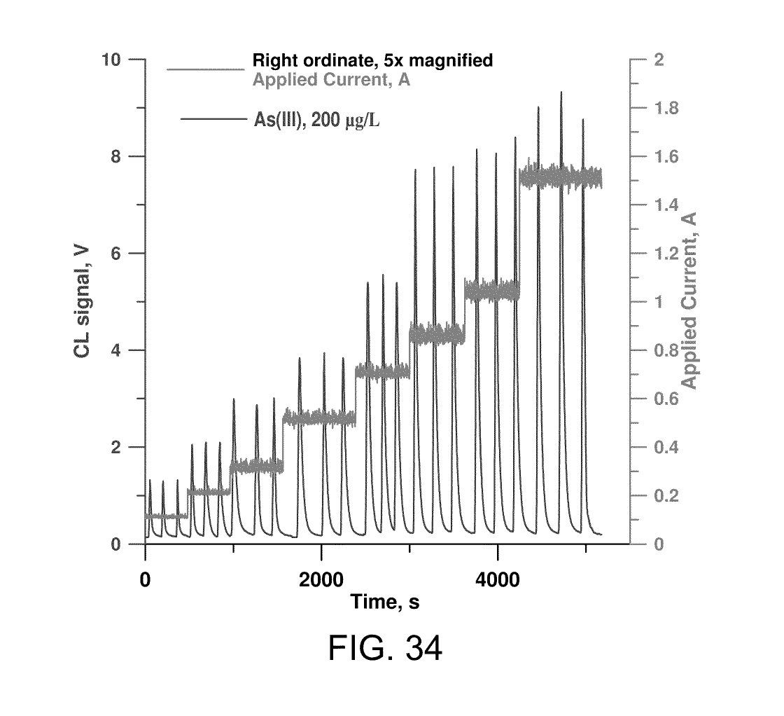

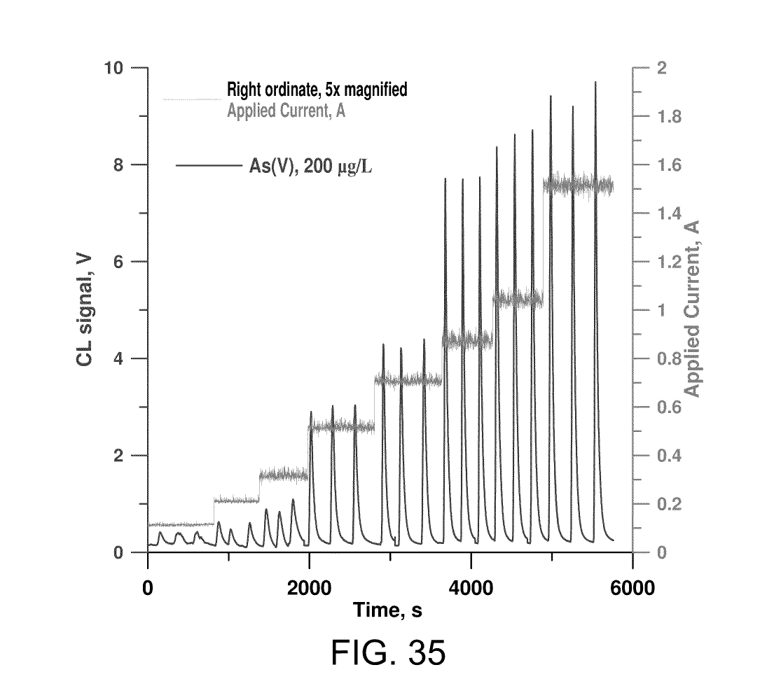

FIGS. 14-27 relate to the embodiments described in FIGS. 1-2 and FIGS. 28-39 relate to the embodiments of FIGS. 5-9. Each of these figures includes various supporting data and information that will be described in greater detail in the examples below.

### EXAMPLES

### Systems and Methods Using Reduction/Oxidation Unit

The example that follows relates only to tests performed on one embodiment of an apparatus similar to that illustrated in FIG. 2. The following examples are for the sole purpose of demonstrating the utility of the described systems and methods, but not intended to be limiting on the scope of the various embodiments described herein.

The reagents used for these examples are commonly available and were obtained from standard suppliers. Except as stated, graphite rods used were electrical discharge machining (EDM) grade graphite rods, type EC-16.

As described above, the apparatus 100 of FIGS. 1-2 have three modules. In one embodiment, the reduction/oxidation module 102 may include a sample and reagent handling module that includes a 48K-step syringe pump SP with a 10-mL syringe and a multiport distribution valve. The pump may deliver sample and reagents to the electrochemical reactor (ECR), remove waste therefrom and also supply deionized wash water (DIW).

In one embodiment, the ECR included a 30 mL plastic syringe barrel SB (P/N 309650, Becton-Dickinson), with a # 4 neoprene stopper (NS) on the inverted end. Three components entered through NS, from the left: (1) the arsine generation electrode, which in this example included a graphite rod GR that is 6.0 mm dia. and 150 mm long, wrapped with poly(tetrafluoroethylene) (PTFE) tape TT to control exposed area, only the bottom 2.5 mm of which was exposed during operation; sufficient length of the electrode protruded through the stopper to be connected to the negative terminal of the power supply PS (Hewlett-Packard 6266B)), (2) a 12 ga. PTFE anolyte inlet line AI (2.1 mm id, 3 mm od), push fit into a porous ceramic tube CT (3 mm id, 5 mm od, 0.2 μm pores). At the bottom of the syringe, first a larger tee (T1, ⅜ in., polypropylene) was affixed and into it was push fit a second, smaller tee (T2, 3/16 in.). The reactor was washed/drained through the T1 side-arm by SP. The bottom of tube CT sealed into T2 and the T2 side-arm provided the anolyte outlet (AO). A Pt foil electrode (45 mm long, 2.5 mm wide) was connected to a 0.25 mm dia. Pt wire. This electrode assembly was inserted into CT through T2 bottom; the protruding wire was sealed in with hot-melt adhesive and connected to PS (+). The micropores in CT provided bulk flow resistance and prevented catholyte-anolyte mixing but ionic passage under applied voltage (and hence current) was easily established. To minimize effective anode area continuously changing from gas bubbles in a narrow tube, the anolyte (˜0.1 M H₂SO₄) was recirculated at 6 mL/min by peristaltic pump PP (Dynamax RP-1). The third component entering NS was a PTFE tube E that carried the liberated AsH₃ to the GPCL detection module 106. After electroreduction proceeded for a preset period, normally closed solenoid valve (SV) opened to let liberated AsH₃/H₂ enter the chemiluminescence chamber CC (externally silvered inverted test tube) sitting atop a photomultiplier tube (PMT) via a glass wool filled liquid trap LT. Ozone was generated with air (5-10 standard cm³/min (sccm) pumped by a small miniature air pump) or with electrogenerated oxygen. The reactant gases exited CC through a MnOOH catalyst bed MC (Carulite 200) to destroy unreacted ozone.

While oxygen can be independently generated and supplied, oxygen anodically generated during EAG was already available. Simple gravity-based gas-liquid partitioning was used. The reservoir vessel RV (1-2 L capacity, 75% filled with 0.1 M H₂SO₄) supplied the anolyte to pump PP that recirculated it through the ECR anode chamber. During electrolysis, the T2 side-arm brought out both the anolyte and O₂. Through another 3/22-in tee T3, the stream entered RV where oxygen accumulated in headspace and passed into the ozonizer (OZG) through a glass wool trap (GT) that removed any liquid droplets; the flow rate at steady state was ˜4 sccm, the same as that produced electrolytically, enough to supply sufficient ozone flow for the CL reaction. In order to maintain a constant liquid level in RV and constant O₂ flow to the OZG, a 3-way solenoid valve IV (both SV and IV) interfaced the ECR via T3 to either RV or SP. During ECR wash, the flowing anolyte went to a temporary container TC and was later resupplied (as a 3-mL aliquot) to RV by SP through T3. Note that water was lost through both electrolysis and by evaporation from the electrically heated liquid via the evolved gases. The acid concentration in RV thus gradually increased. With 1-L capacity, RV 75% filled in the beginning and an EAG current of 1 A and operating at an ambient temperature of 23° C., the inventors found that the acid level could be maintained constant if instead of the acid, 3-mL water was supplied after every 19 samples. For an anolyte concentration around 0.1 M H₂SO₄, minor increases in concentration did not greatly influence the analyte response.

Initially, anolyte flow from RV to the ECR anode chamber was started by pump PP. SP then introduced 5.0 mL sample, followed by 2.0 mL 0.5 M H₂SO₄ as the outer catholyte. Electrolysis began immediately; a constant current of 1 A was maintained, requiring 15-18 V. Electrolysis gases were allowed to accumulate for 60 s before SV opened for the next 5 min and electrogenerated AsH₃ proceeded completely to CC. After measuring the CL signal, IV connected to SP; SP withdrew the catholyte and sent it to waste. Depending on the desired degree of sample carryover, up to 10 mL of water was pumped into the ECR and kept for 30 s before aspirating off. IV closed, followed by a 3 mL addition 0.1 M H₂SO₄ from TC to RV. The entire cycle was ˜8 min/sample.

Initial optimization of gas flow rates, electrolyte concentration/flow rates were performed using platinum anode and cathode. Platinum as anode provides the needed inertness; it was also initially selected as cathode based on its reported use in EAG systems, albeit some report low efficiency. After the final cathode choice, electrolyte concentration/flow rates were re-optimized. Glass and polypropylene ECR bodies performed equally well; we retained the plastic disposable syringe. The cathode and anode compartments requires a bulk flow barrier; initial comparison of the ceramic tube used with Nafion tubing (4.5/6.6 mm id/od) in 1.0/0.2 M H₂SO₄ catholyte/anolyte showed 30% less resistance for the ceramic tube based cell; it was henceforth used.

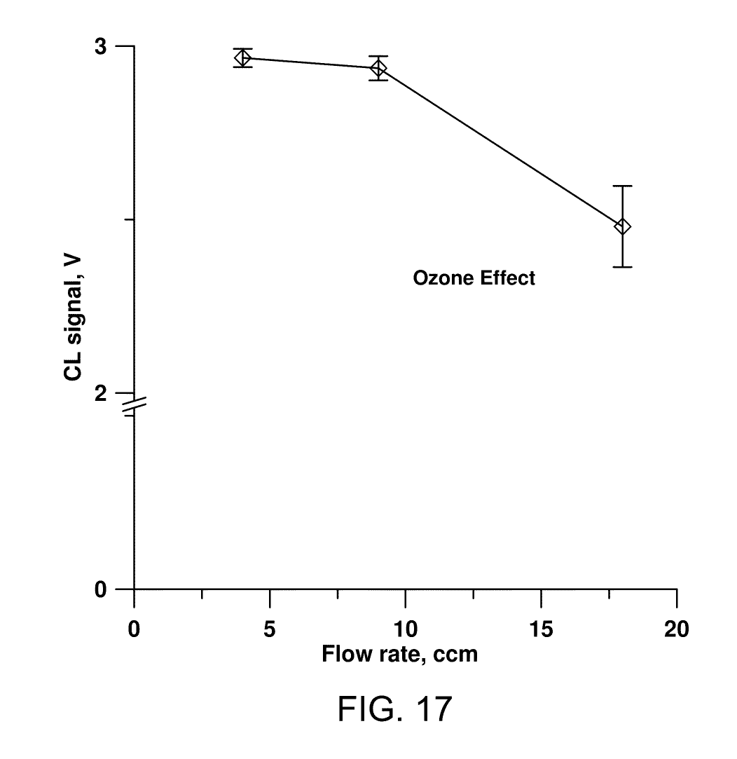

The GPCL signal depends in a complex fashion on the ozonizer flow rate. At high flow rates, generated [O₃] is reciprocally related to the air/O₂ feed rate (constant mass of ozone produced). At very low flow rates, a maximum plateau concentration was seen (this equilibrium concentration is ˜5× higher for O₂ than for air). The AₛH₃—O₃ reaction is not instantaneous, higher [O₃] leads to a faster reaction and a sharper signal. However, a high flow of O₃ reduces the cell residence time and the reactants escape the PMT view before reaction completion. The relevant [O₃] value here is that in the cell, after dilution with the AsH₃/H₂ flow. Consider that electrolytic H₂ produced with 1 A current is 7 sccm; accordingly, we found that 4-9 sccm ozonizer flow produces the maximum CL intensity; a further flow increase decreases the signal (details can be seen in FIG. 17). Thus, 4 sccm oxygen or 7 sccm air feed flow into the ozonizer may be selected.

The cathode is critical for EAG and affects hydride generation efficiency and reproducibility; acidic sample compatibility is also important. Carbon in different forms and lead have been most commonly used in electrochemical hydride generation (EHG) systems; they tolerate acidic media; proponents report better EHG efficiency than other cathodes. However, carbon electrodes also reportedly show a sufficiently lower response for As(V) compared to As(III) that pre-reduction is essentially mandatory. A Pb cathode reportedly suffers from interferences by high concentrations of other elements. It is difficult to compare different literature reports as no two use the same conditions. We compared the performance of 20 metals (Pb, Sn, Zn, Ni, Nb, Cd, Co, C (graphite), Mo, Ti, W, In, Zr, Ta, Pd, V, Nd, Pt, Cu and Al) and two alloys (Ni—Cr and type 316 stainless steel) as cathodes. Most electrodes were initially tested as 1×1 cm foils, with a 0.25 mm Pt-wire providing electrical connection; Ni—Cr was tested as a 40-mesh gauze of equivalent electrode area. All cathode materials were tested using 50 μg/L As(III) and As(V) each, with a Pt anode, 0.1/0.5 M H₂SO₄ as catholyte/anolyte (latter recirculated @ 6 mL/min) and a constant current of 1.0 A. (These are default conditions for all experiments unless otherwise stated.)

A recent study suggests that EHG takes place in four steps: (a) diffusion of the analyte to the cathode (it is thus essential to convert As(V) to an uncharged species by a strongly acidic medium); (b) reduction to the element on the cathode surface (c) reduction of water to hydrogen, also on the cathode surface and formation of the hydride thereon and (d) diffusion of the hydride away from the electrode. [Laborda, F.; Bolea, E.; Castillo, J. R. Anal. Bioanal. Chem. 2007, 388, 743-751.] Hydride generation efficiencies are the parameters of general interest. Interference by high levels of other metals, sometimes considered a performance parameter, is not relevant in drinking water analysis. In FIG. 3, the response of different cathodes towards 50 μg/L of As(III) and As(V) are shown with the As(III) response of a platinum cathode taken as unity. Hydrogen evolution overpotential (HEO) of a metal has often been regarded as an important parameter in governing EAG cathode behavior. With higher HEO values, more of the atomic hydrogen will still be on the electrode surface and thus take part in hydride formation. HEO is a function of the solution composition and current density. HEO was measured at various current densities for several electrode materials and EAG efficiencies reported did track the HEO values. Further, on electrodes such as Pb, Cd and amalgamated silver, some reported that As(V) could be reduced as easily as As(III). This was not presently found to be the case.

Neodymium was the only metal that produced no signal; the Nd electrode could not be kept from dissolving even with high negative voltages applied. Electrodes of graphite, Al, V, Zn, In, Sn, Pb, Pd and stainless steel (316SS) were more effective than Pt for the reduction of As(III). Only Al produced statistically equivalent responses for As(III) and As(V). Appreciable As(V) response was also produced by Zn, In, Pb, 316SS, and to a smaller extent, the graphite electrodes. Al, Zn, and V slowly eroded even with cathodic potential applied; considering the low cost and ready availability of Al foil, it may nevertheless be possible to design a disposable Al electrode based device. In these initial experiments, graphite showed the highest As(III) response but the variability was high. The imprecision came from the fragile nature of the graphite foil and the difficulty of reproducibly establishing electrical connections. Switching to a mechanically robust graphite rod solved reproducibility issues.

All aspects of EAG cathode behavior is not revealed by FIG. 3; these data represent stable signals that are finally obtained when 50 μg/L As is repeatedly injected. Cathodes of Mo, W, In, Zn, Zr, Pd, V and 316SS exhibited varying degrees of memory; i.e., starting from a blank when the first standard was injected, the response was low. Only after a number of injections was a steady stable response observed. Similarly, returning to blanks did not immediately produce a zero response. This may be related to specific metals forming surface alloys/intermetallic composites with As. The extant literature indicates cathode preconditioning, whether by mechanical scrubbing/polishing, chemical oxidation by brief immersion in nitric/chromic acids or electrochemical polarity reversal, is often necessary. In the experiments, the need for such conditioning varied considerably: electrodes of Cd, Ni—Cr, Sn, Co, In and Ni required frequent conditioning—otherwise after about an hour of operation, the response decreased.

Based on these results, 316SS, Pb and 2 different types of carbon (graphite, and high purity spectroscopic grade carbon rods) were selected for further investigation. Reproducibility was checked over 3-6 consecutive days on the same electrode; the 316 SS and Pb electrodes were foils while both carbon electrodes were 3-6 mm dia. rods. Response to 50 μg/L As(III) is shown in FIG. 4, the response with a 316SS cathode was the lowest and typically exhibited the highest within-day variance. Lead showed great variability between the first and subsequent days. Spectroscopic carbon response increased over days; it is possible with this and the Pb electrodes that deposition of impurity metals (including As) or surface alteration leads to better performance. By far the best performance, in terms of response, within-day and between-day reproducibilities, was observed with the graphite cathodes. Intra-day or inter-day precision were <5% in relative standard deviation (rsd); no memory effects were observed and no conditioning was required. EAG performance difference of different carbon types has been noted by others as well. Graphite rods were henceforth used.

As the acidic electrolyte for EAG; H₂SO₄ may be used. In alternative embodiments, HCl, HClO₄, HNO₃, and others may be used. The chemiluminescence (CL) intensity of 50 μg/L of As(III) and As(V) as a function of varying anolyte H₂SO₄ concentrations (0.01-2.0 M) is shown in FIG. 14. Both As(III) and As(V) showed qualitatively the same pattern, although As(III) absolute signals were much higher. The CL signals increased dramatically from 0.01 to 0.1 M H₂SO₄ and decreased slowly thereafter (decreasing by ˜<10% in going from 0.1 M to 0.2 M H₂SO₄); hence 0.1 M H₂SO₄ was chosen as anolyte.

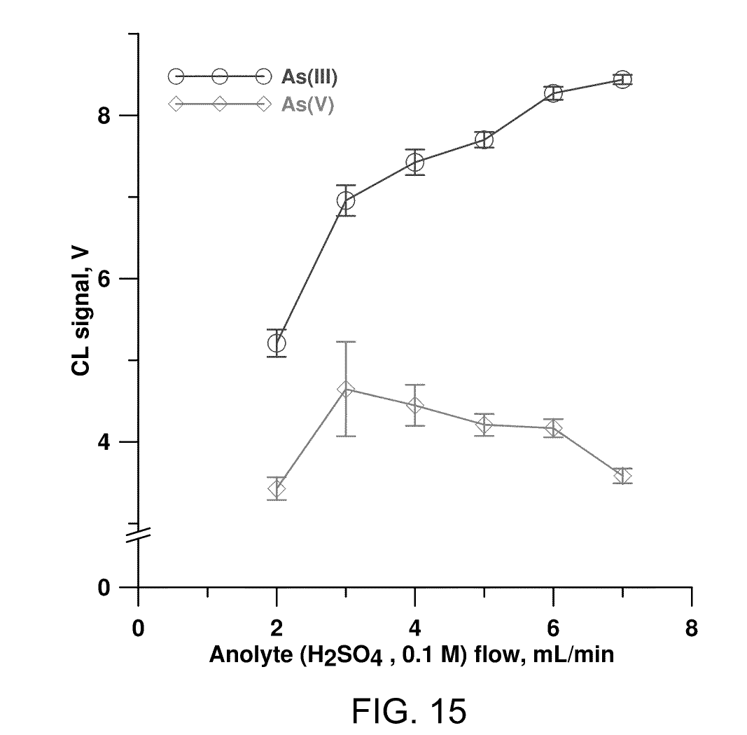

The anolyte is made to flow; else gas bubbles in the small anode compartment disrupt steady state operation. Bottom-up flow may seem to be better for gas removal but the anodic gas can go through the ceramic tube to the outer headspace if driven above the outer liquid level. The efficacy of flow-driven gas bubble removal increases with the anode liquid flow velocity/rate. Although the electronics can be configured for constant current, at low anolyte flow rates with gas bubbles mostly covering the anode applied voltage increases erratically and steeply, generating large amounts of heat. As(III) and As(V) responded somewhat differently to anolyte flow (FIG. 15); the specific reason for this is not understood. But in both cases, a recirculation rate of 6 mL/min gave the optimum combination of sensitivity and precision; this was adopted.

For catholyte, 0.25-2.0 M H₂SO₄, was selected with 0.1 M H₂SO₄ as anolyte. As shown in FIG. 14, for both As(III) and As(V), the CL signal decreased with increasing [H₂SO₄], at first slowly and later more steeply. The higher voltage and higher power dissipated at constant current with a more resistive catholyte may be leading to a higher catholyte temperature and hence, greater arsine efflux. Precision was much better for 0.5 M, rather than 0.25 M H₂SO₄ as catholyte, we therefore chose the former.

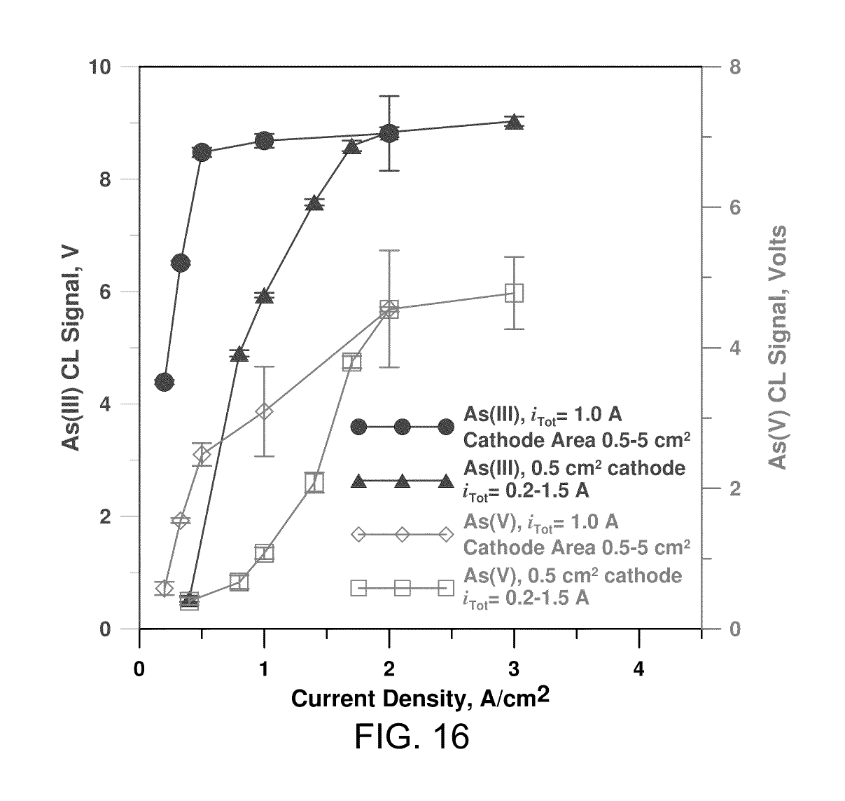

For any given electrode, the HEO increases with increasing current density. Whether or not HEO is directly involved, it is reasonable that as more electrons are pumped in per unit electrode area and atomic hydrogen forms, more of it will be available for hydride formation reactions. In FIG. 16 it is shown that the CL response of As(III) as a function of current density. In one set of experiments (triangles) current density was varied by varying the current at a constant cathode area of 0.5 cm² whereas in the other set (circles), the cathode area was varied at a constant current of 1.0 A. Both sets of data approach a plateau value at high current densities with an approximate first order dependence. This plateau signal (area) is 95% of the signal obtained with a very powerful chemical reducing agent such as NaBH₄, indicating near-quantitative reduction. The two curves intersect where the conditions are the same (i=1.0 A, Cathode area=0.5 cm²). These data indicate that both current and current density may be important. The constant current—variable current density data (circles) underscores the importance of current density. Yet, the triangles always fall below the circles at low current densities (although a greater electrode area may help analyte capture); hence, the absolute value of the current may also be important.

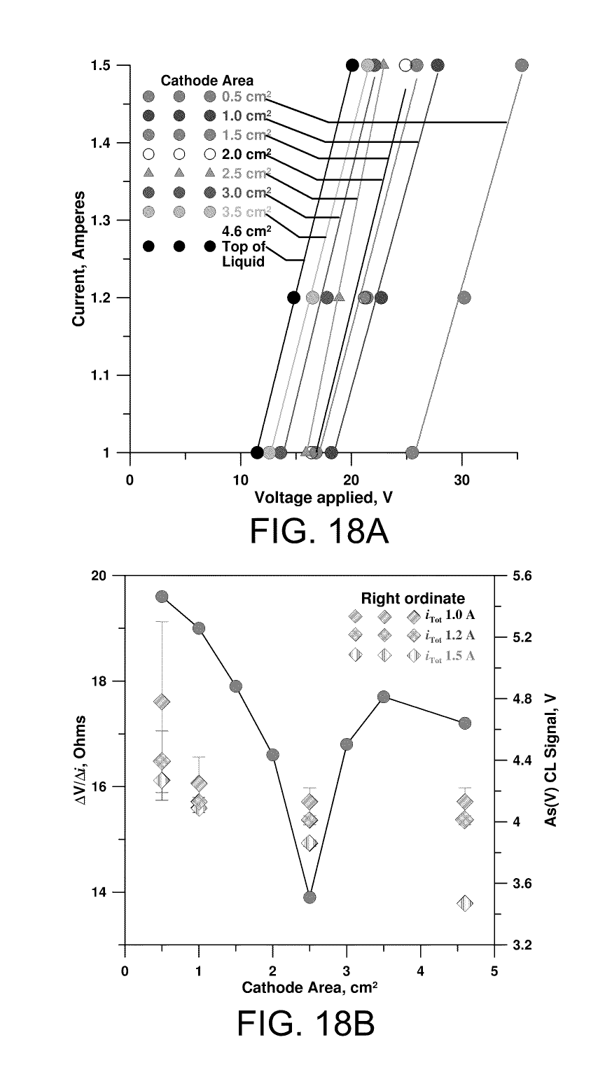

The As(V) data in FIG. 16 are qualitatively similar to those for As(III) except the response is lower. The current density dependence at constant current shows two distinct regions of slope, possibly suggesting that the ultimate reduction to AsH₃ may be taking place in two steps. Experience also indicated that maintaining a high current density solely by reducing the cathode area leads to cathode erosion. An electrode area of 1 cm²; at a constant current of 1.0 A was selected, and this gave statistically identical signal intensities as a 0.5 cm² electrode and better precision. More extended rationale for choosing this electrode area is given in FIG. 18A.

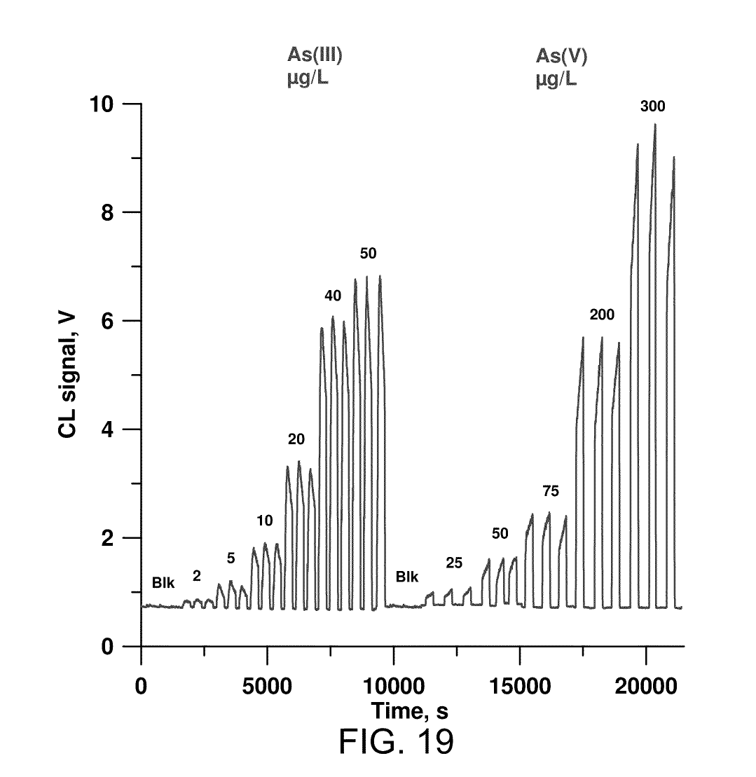

Minimally, one would like to measure total As in the samples of interest. It would be nice to separately measure As(III) and As(V). The experience is that in practical EAG systems where the cathodes exhibit a minimum of memory effects and conditioning needs, a response difference between As(III) and As(V) is unavoidable. This is shared by others; at least there is no extant literature that performs EAG on real samples and can reliably determine total As without prior conversion of one species into the other. Under optimum anolyte/catholyte conditions, in an air-based ozone generation system, linear responses were obtained (linear r² values >0.99) for both As(III) and As(V) with respective slopes of 132 and 29.5 mV/(μg/L As). For the O₂-based ozone generation system, slopes of 170.6 and 81.6 mV/(μg/L As) was obtained respectively for As(III) and As(V), r²>0.99 (see FIGS. 19-21). While the difference between As(III) and As(V) signal heights does decrease with oxygen-based ozone generation, the disparity is still too large.

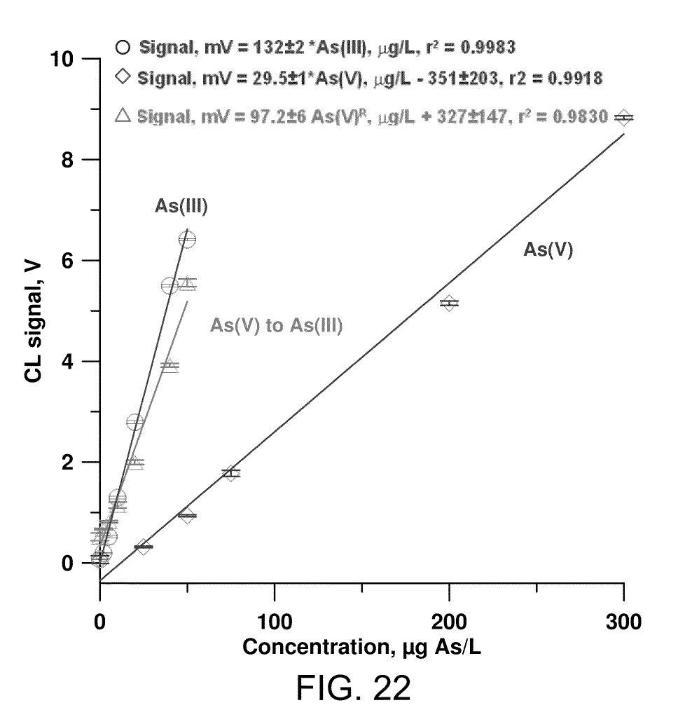

Because As(III) is more responsive, we first explored reduction by KI—ascorbic acid. At 50 μg/L As(V), ˜80% was converted to As(III) as judged by the response; this did not improve by increasing the reduction time from 3 to 5 min. In addition: (a) the blank signal increased, deteriorating LOD to 1 μg/L As, suggesting presence of As in the relatively concentrated reductant (or CL from some substance derived from the reductant); and (b) the linearity decreased significantly (r²=0.98): data in FIG. 22 indicate that reduction is less complete at higher [As(V)], characteristic of an equilibrium-driven process.

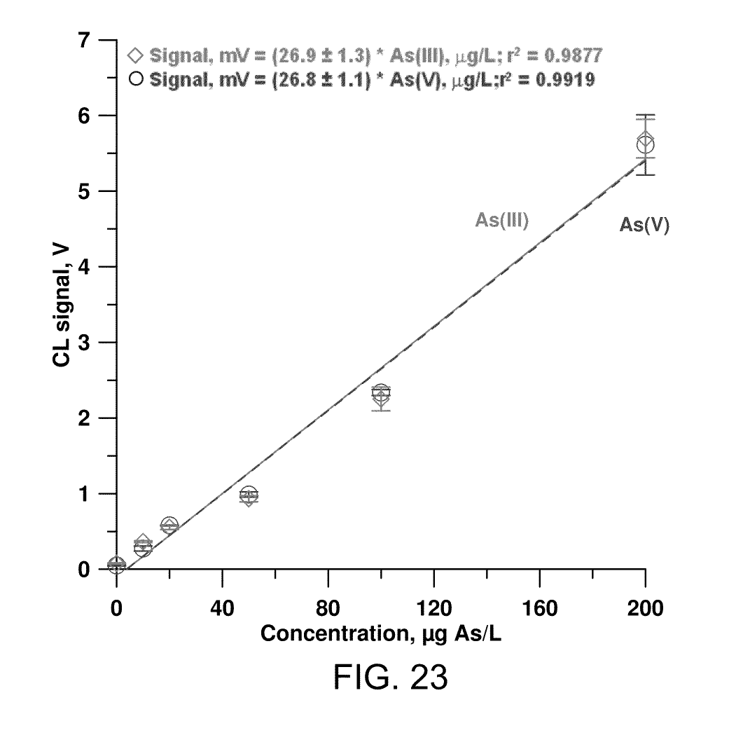

Pre-EAG oxidation of As(III) to As(V) is usually not attempted because of sensitivity loss. Even an air-ozonizer GPCL approach may nevertheless provide sufficient sensitivity for drinking water analysis in South Asia; thus NaOCl, an inexpensive strong oxidizing agent, was chosen. A small amount (0.1 mL of 0.6% w/v NaOCl) was added to the ECR after sample introduction. Identical response slopes were observed (26.9±1.3 and 26.8±1.1 mV/(μg/L) As(III) and As(V) originally taken) with intercepts indistinguishable from zero (see FIGS. 22 and 23). The reproducibility permitted an S/N=3 LOD of 0.65 μg/L, better than that obtained with KI-ascorbate reduction.

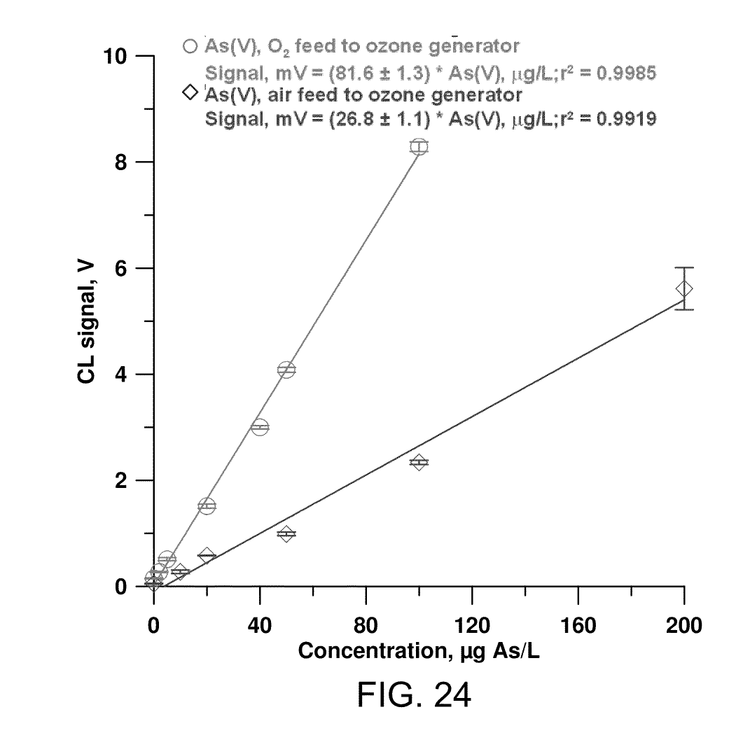

If O₂ instead of air is used for ozone generation, the CL signal increases markedly. But for a field instrument, carrying an oxygen tank is a burden. Oxygen is, however, generated during EAG and is readily available for ozone generation. Under conditions described above, we indeed observed 3× better sensitivity (details: FIG. 24) and 2× better LOD (0.36 μg As/L) compared to the air-based ozone generation, more than sufficient to meet drinking water As analysis needs.

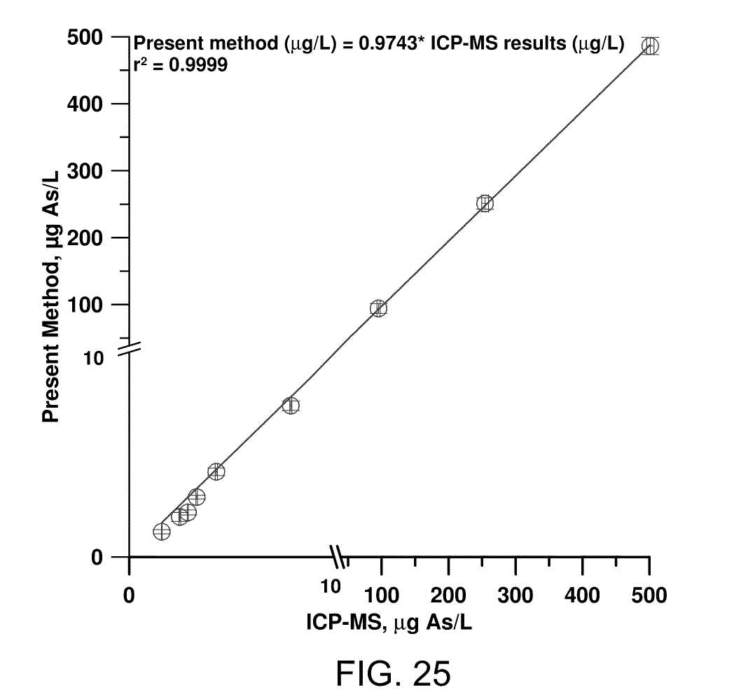

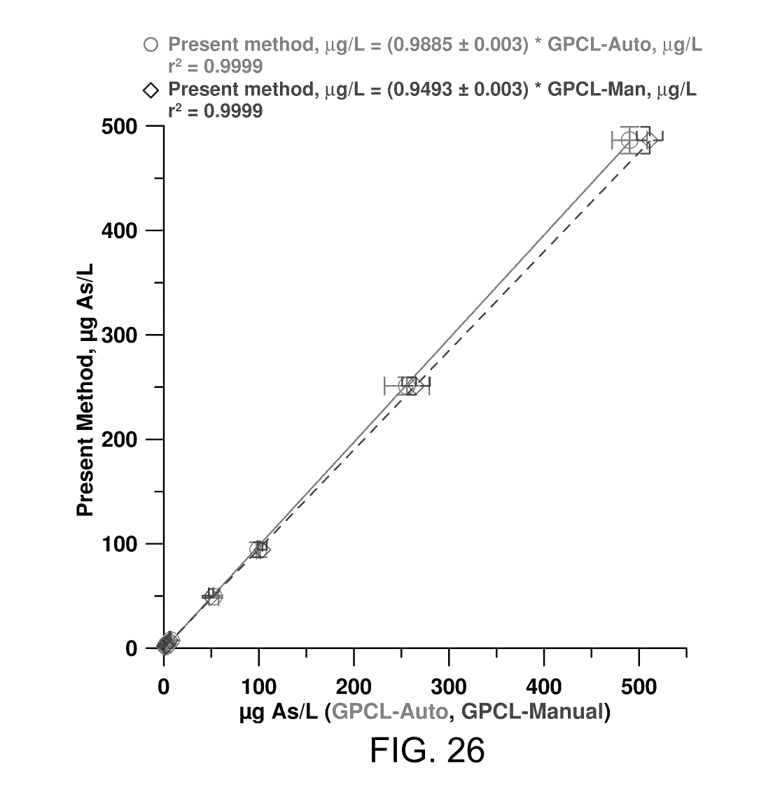

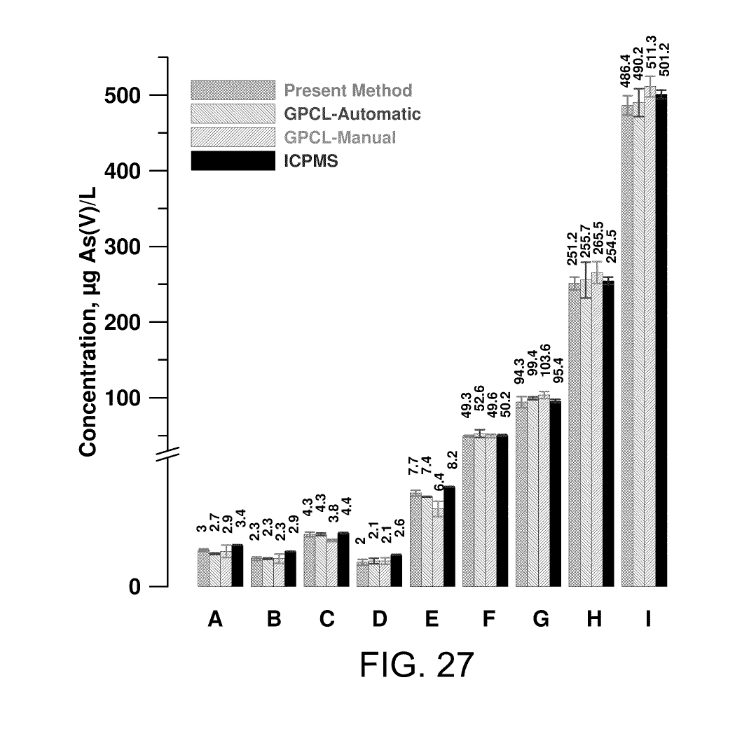

Six tap water samples from Western Texas/Eastern New Mexico were analyzed. These regional samples had very high total dissolved solids (TDS), high total hardness and contained low levels of As(<10 μg/L; a 2008 report of Lubbock, Tex. water reports these respective parameters at 830, 260 and 0.0021-0.0039 mg/L). High mineral and low arsenic content provides a challenging end of drinking water samples. Naturally occurring higher arsenic content samples were not available, so to provide samples at the high end, local tap water spiked with As(V) (˜200 mg/L TDS, ˜100 mg/L total hardness, <1 μg/L Total As). The results showed excellent correlation between the present method and ICP-MS (r²=0.9999, slope 0.97, intercept statistically indistinguishable from zero, ICP-MS; a plot is shown in FIG. 25). In addition, the results were compared on the same samples with chemical reduction hydride generation—GPCL methods; both the automated and manual versions. Comparison with these two methods also both exhibited linear r² values ≧0.9999, with a slope of 0.99 and 0.95 vs. the automated and the manual methods (details appear in FIG. 26 and all the intercomparison data are summarized in FIG. 27).

In the example above, stock standards of 100 mg As/L were prepared. Inorganic As(III) and As(V) were prepared in 1 mM HCl from As₂O₃ and Na₂HAsO₄.7H₂O (both from J. T. Baker), respectively. Lower concentrations were prepared by dilutions with (18.2 MΩ cm) Milli-Q deionized water (DIW). Different concentrations of electrolytes used for arsine generation were prepared from sulfuric acid (17.8 M, EMD Chemicals Inc.). Potassium iodide (Mallinckrodt) and ascorbic acid (Mallinckrodt) were used as reductant for reducing As(V) and sodium hypochlorite (bleach, bought as 5.25% w/v NaOCl) was used as oxidant for oxidizing As(III). See Table 1 for electrode material list. The parts listed in Table 1 may be purchased online from VWR International or GraphiteStore.com, Inc.

Liquid Dispensing Module: 48000-step syringe pump SP (P/N 54022) with an 8-port distribution valve DV (P/N 19323) and a 10-mL zero dead volume UHMWPE tip glass syringe S was used for automated sample/reagent uptake, delivery and washing the ECR.

Chemiluminescence chamber (CC): CC is made from a glass test tube externally silvered and black coated to prevent light leakage, sealed at the bottom with a glass disc which remains uncoated and acts as a window. The tube was drilled at three places for the entrance of arsine from top one end, ozone from the other top end. The third end sits just above the window base; serves as the exit line from where the reacted arsine-O₃ mixture exits. For ozone generation, a miniaturized air pump operated at 24 V (AP, Bühler, Germany) connected with an air drying and purification column comprising of serial beds of activated charcoal and a gel at the inlet; supplies the purified air to a commercial silent discharge type ozone generator (OZG; EOZ-300Y; available from Enaly) flowing into CC at 8 sccm. The CC sits atop a H5784 PMT (Hamamatsu Photonics K.K.) with a built-in high voltage (HV) power supply serve as the detector, operating at a control voltage of 0.85 V with a secondary stage amplification of 1000×.

TABLE 1
Description and source of electrode materials tested

Lead foil, thickness 0.1 mm, 150 × 150 mm, P/N AA42708-VA
Tin foil, thickness 0.25, 50 × 50 mm, P/N AA43233-FI
Zinc foil, thickness 0.62, 100 × 150 mm, P/N 100209-894
Nickel Chromium gauze, thickness 40 mesh, 0.25 mm, 75 × 75 mm,
P/N AA40941-FL
Niobium foil, thickness 0.25, 25 × 25 mm, P/N AA00238-FF
Cadmium foil thickness 0.1 mm, 50 × 50 mm, P/N AA11371-FI
Cobalt foil thickness 0.1 mm, 25 × 25 mm, P/N AA42658-FF
Graphite foil, 0.254 mm, 150 × 150 mm, P/N AA10832-VA
Molybdenum foil, thickness 0.127 mm, 100 × 150 mm, P/N AA10043-GJ
Titanium foil, thickness 0.127, 25 × 25 mm, VWR Parts No. AA13976-FF
Tungsten foil, thickness 0.1, 50 × 50 mm, P/N AA10416-FI
Indium foil, thickness 0.127 mm, 50 × 50 mm, P/N AA12206-FI
Zirconium foil, thickness 0.127, 100 × 125 mm, P/N AA10594-GM
Tantalum foil, thickness 0.25, 50 × 50 mm, P/N AA10353-FI
Palladium foil, thickness 0.1, 25 × 25 mm, P/N AA11515-FF
Nickel foil, thickness 0.127 mm, 20 × 30 cm, P/N AA1095-CH
Vanadium foil, thickness 0.127, 50 × 100 mm, P/N AA13783-FY
Neodymium foil, thickness 0.1 mm, 25 × 25 mm, P/N AA13964-FF
Platinum foil, thickness 0.127 mm, 25 × 25 mm, P/N AA00261-FI
Copper foil, thickness 0.1 mm, 100 × 100 mm P/N AA42973-GH
Aluminum foil, Reynolds Wrap Aluminum Foil, 16 0.67 yds × 18 in).
Spectroscopic Carbon rods 0.25″ dia. × 12′ L, National spectroscopic
carbon.
Graphite rods, Fine Detail, Fine Finish EDM Rod, 0.125″ dia × 12″ L,
MW001012
Stainless Steel foil, thickness 0.2 mm, 100 × 100 mm P/N AA42973-GH
Nichrome Gauze, thickness 0.09 inch, P/N 66232-029

During recirculation, sulfate is electrically driven into the anode compartment. Theoretically, at a current level of 1 A assuming an anolyte initial volume of 0.75 L, the concentration of the anolyte H₂SO₄ will increases 0.025 M/hour (if the current was continuously flowing; in reality, the current is on only a small fraction of the analytical cycle). If the catholyte contains a significantly higher acid concentration than the anolyte, then this increase can be further augmented by water transport from the anolyte to the catholyte. Overall, experimentally we found that with 0.5 M/0.1 M H₂SO₄ (0.75 L) as catholyte/anolyte, addition of 3 mL water to the anolyte every 150 min of operation (approximately 18-19 samples continuously run) maintains a constant anolyte concentration.

In the present system, other reagents can be delivered by the liquid handling module. One mL each of a solution containing 5% KI and 5% ascorbic acid was added immediately after the As(III) sample was introduced to the ECR. The ECR exit valve was opened 3 min after this reductant introduction, providing 2 additional minutes for the reduction of As(V) compared to the standard protocol.

Systems and Methods without Reduction/Oxidation Unit

The example that follows relates only to tests performed on one embodiment of an apparatus similar to that illustrated in FIG. 7. The following examples are for the sole purpose of demonstrating the utility of the described systems and methods, but not intended to be limiting on the scope of the various embodiments described herein.

The CF-EAG-GPCL is primarily a flow based set-up, where electrolyte and effluents are being flown using peristaltic pump, PP. A sample injection valve (SIV) introduces the sample to the electrochemical reactor (ECR) along with the electrolyte made from a graphite rod acting as a cathodic chamber, holding the anodic chamber inside its cavity as shown in FIG. 7. Both the cathode and the anode are connected to a power supply (PS), which initiates the electrolysis. A custom designed microporous tube based gas-liquid separator (GLS-mPT) made of a micro-porous tube placed beyond the ECR, separates the arsine from the post-ECR mixture and releases it to the CL chamber (CC). The electrogenerated O₂ liberated from anodic half collected at the oxygen reservoir (OR) proceeds towards the ozone generator (OZG) as O₂ feeder also enters the CC, which is placed atop a photosensor module (PSM) acting as a CL detector. The entire system schematic is presented in FIG. 7.

At first, PP1 starts pumping the electrolyte to the ECR, followed by electrolyte withdrawal from anolyte outlet (AO) and catholyte outlet (CO) by PP2; electrolysis immediately begins at constant current either at 0.85 A or 0.1 A depending upon total As or As(III) being measured, generating ˜12-14 or 4-6 V, respectively, to the applied current. Once the system is stable, sample injection generally initiates. One mL of sample is injected through SIV and the corresponding electrogenerated arsine exits out from CO and enters the CC via GLS-mPT. Anodically generated O₂ accumulates at the headspace of the OR and feeds the ozonizer (OZG) for supplying ozone to the CC. Upon AsH₃—O₃ mixing, a CL is generated inside the CC, which is being detected by an H5784 photomultiplier tube (PMT) detector operated at a control voltage 0.85 V. Once the CL reaction is over, the mixture exits out from the CC through a MnOOH catalyst cartridge, MCC (Carulite 200), which destroys the unreacted ozone. The entire cycle is ˜4 min for total As and ˜7 min for As(III) detection. Except as stated, results reported herein are based on peak height and reported as average±sd (n=3).

In one embodiment of the apparatus, the performance of a graphite rod may be the best with respect to sensitivity and reproducibility as the cathode and Pt wire as the anode.

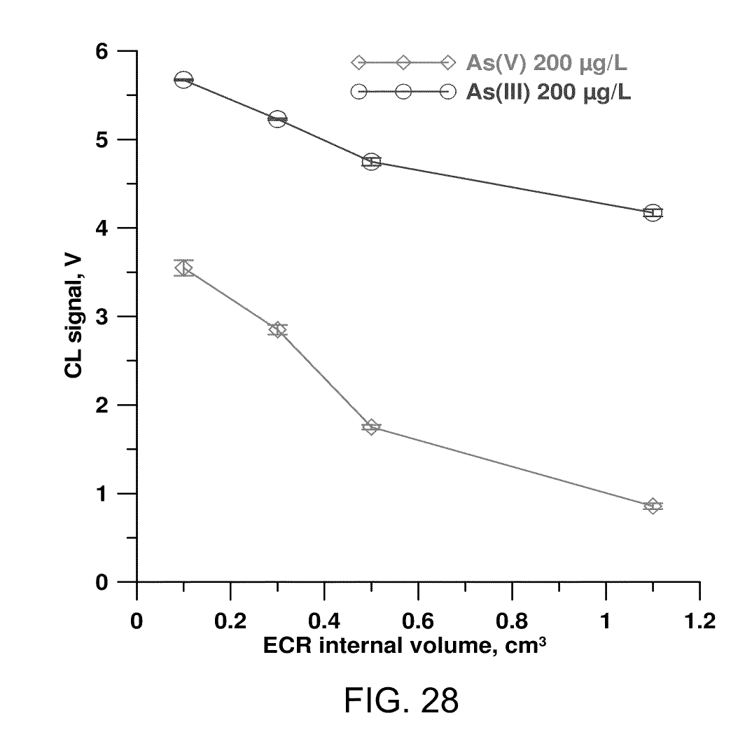

The entire ECR may be a flow through assembly made from a graphite rod acting as cathode within which the anodic chamber sits in a concentric fashion. In order to study the efficiency of arsine generation as a function of surface area, we varied the cathode area by varying the ECR size. Four different sizes of ECR were constructed varying the length or diameter of the graphite rod having internal volume 0.1, 0.3, 0.5 and 1.1 cm³. As shown in FIG. 28, the lowest volume ECR generates highest sensitivity towards arsine generation. At a fixed applied current, the lower the surface area the higher will be its current density and the mass transfer, leading to a better arsine efflux. Based on this observation, 0.01 dia—(low volume) ECR was selected.

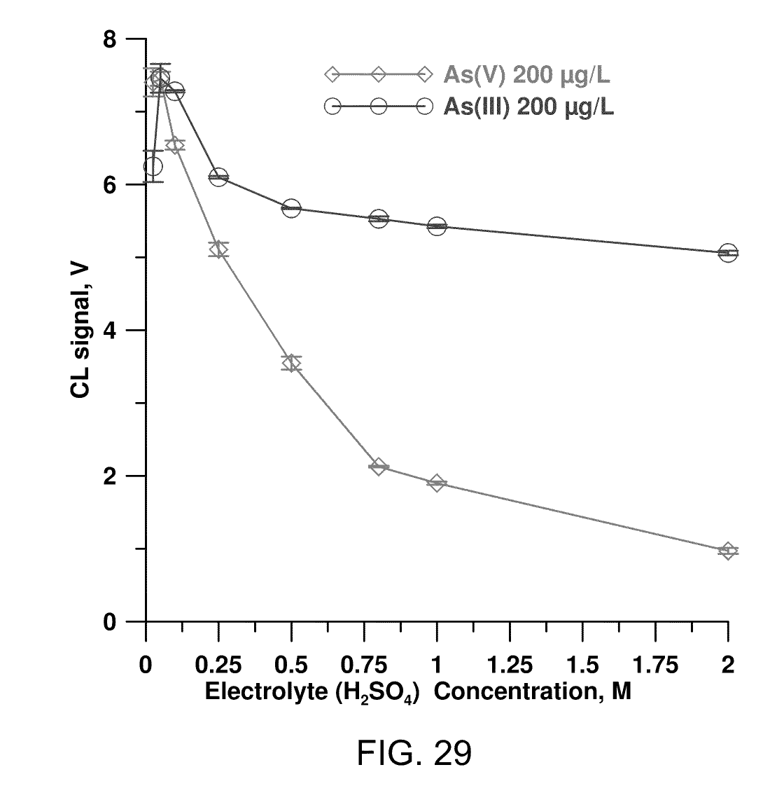

H₂SO₄ as an electrolyte was chosen due to its better performance compared to other inorganic acids for arsine generation. The effect of H₂SO₄ concentrations ranging from 0.025-4 M with the flow setup were also tested. As illustrated in FIG. 29, the response of As(III) initially increased from 0.025 to 0.05 M and then decreased gradually with increasing H₂SO₄ concentration. A similar trend was observed with a steady decrease in As(V) response with increasing H₂SO₄ concentration. This response pattern for both As(III) and As(V) may be due to higher resistivity at lower concentration, which evidently increases the electrolysis voltage leading to a higher solution temperature facilitating better arsine transport. 0.05 M H₂SO₄ was selected as the final electrolyte concentration.

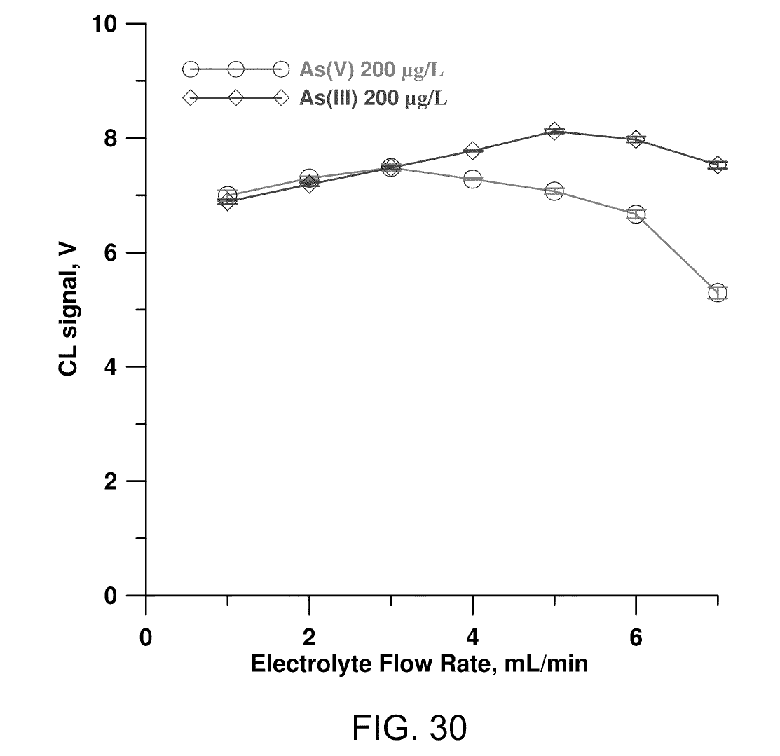

For a continuous flow set up, flow rate of the electrolyte is important as it governs the arsine generation efficiency. Flow rate within the range of 1-8 mL/min was considered. The response for As(III) and As(V) was found to be somewhat different, as depicted in FIG. 30. As(III) increases with increasing flow rate from 1-6 mL/min, reaches its maximum, and then decreases thereafter, whereas As(V) increases from 1 mL/min, reaches its maximum at 3 mL/min, and gradually decreases thereafter. As the flow rate directly influences the mass transfer of an analyte, the contact time between the analyte at a fixed surface area increases with decreasing flow rate thus achieving higher efficiency for As(V) at lower flow rate. In the case of As(III), which forms hydride faster than As(V), lowering the flow rate is counterproductive as it affects the sample throughput. However at higher flow rates, more analyte escapes out without getting reduced on the cathode surface, leading to lower response for both As(III) and As(V). An electrolyte flow of 3 mL/min was selected.

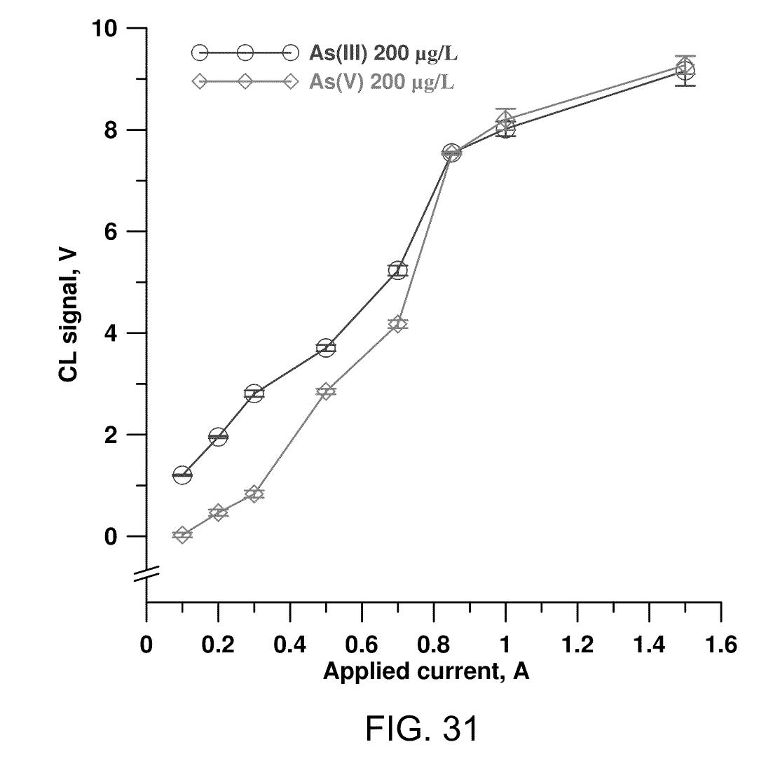

The effect of applied electrolysis current and current density on arsine generation efficiency was considered. In this test, both the applied current and current density played a significant role. Moreover, it was observed that the response factor for As(V) at higher current is greater than As(III). A statistically similar response for both As(III) and As(V) was noted at an applied current of 0.85 A, as evident from FIG. 31 and FIGS. 34 and 35. It was further observed that the response of As(V) is negligible at an electrolysis current of 0.1 A, while As(III) responds. This difference in signal of As(V) at different applied current formed the basis for speciation and total As measurement study.

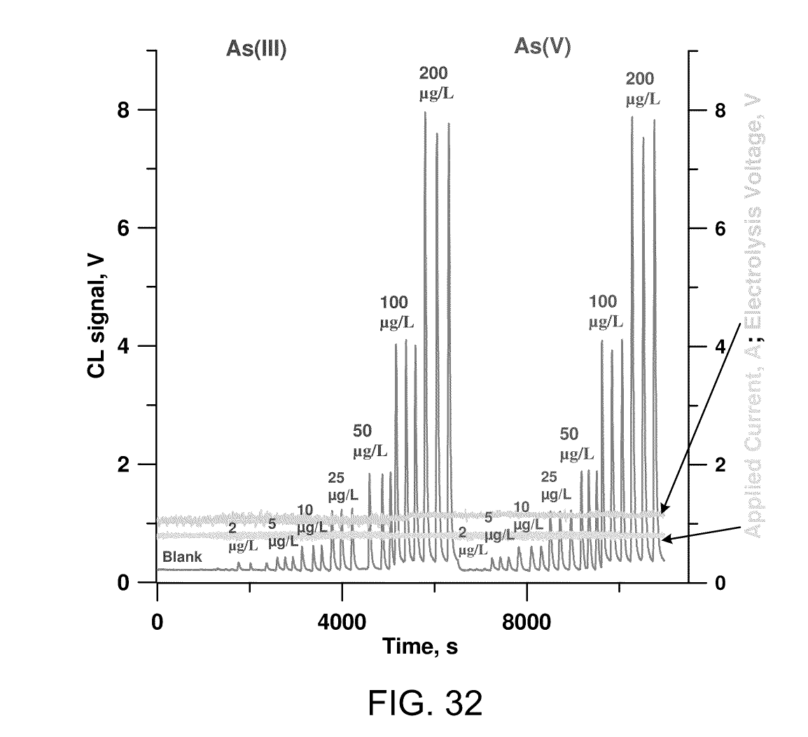

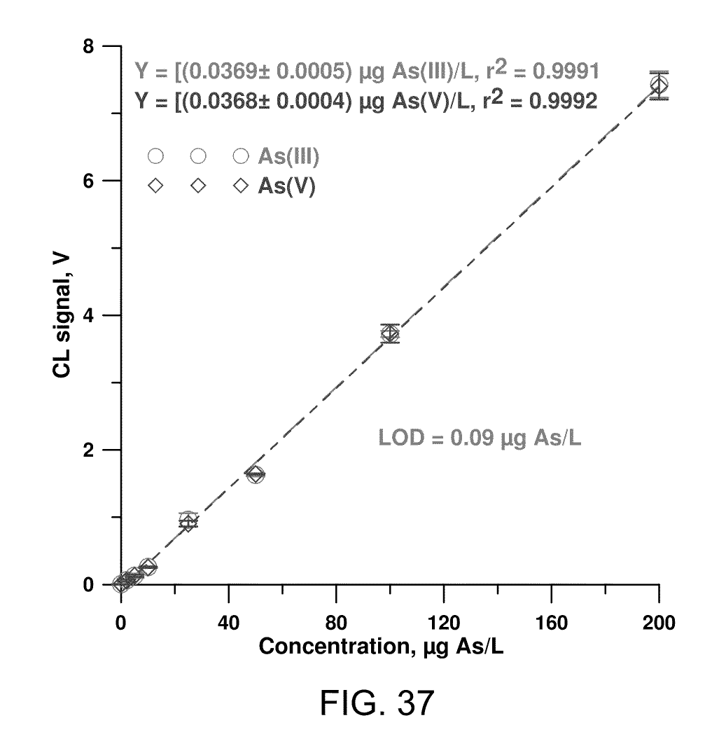

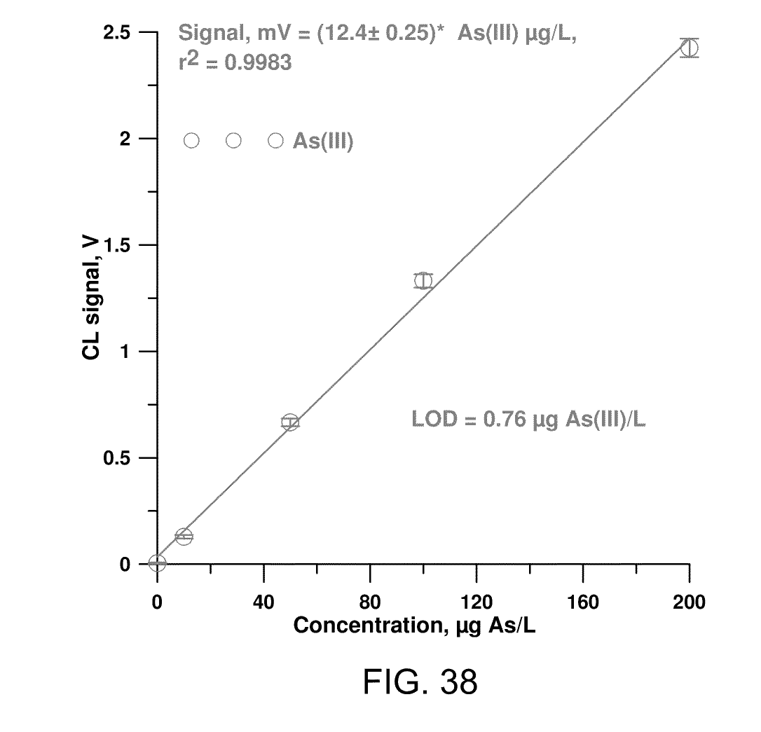

Under optimized conditions, total As was measured from different sets of As(III) and As(V) standards separately at an electrolysis current of 0.85 A. The CF-EAG GPCL setup provided statistically indistinguishable calibrations for As(III) and As(V), suggesting that either As(III) or As(V) standards can be used as a calibrant for total As detection, as shown in FIG. 37. As(III) can be measured separately at an operating current of 0.1 A as shown FIG. 38. A response plot for As(III) and As(V) is shown in FIG. 32. For a 1 mL sample, the limit of detection (LOD) based on S/N=3 were found to be 0.09 and 0.76 μg/L for Tot. As and As(III). As(V) can be obtained as a calculated difference between Tot. As and As(III).

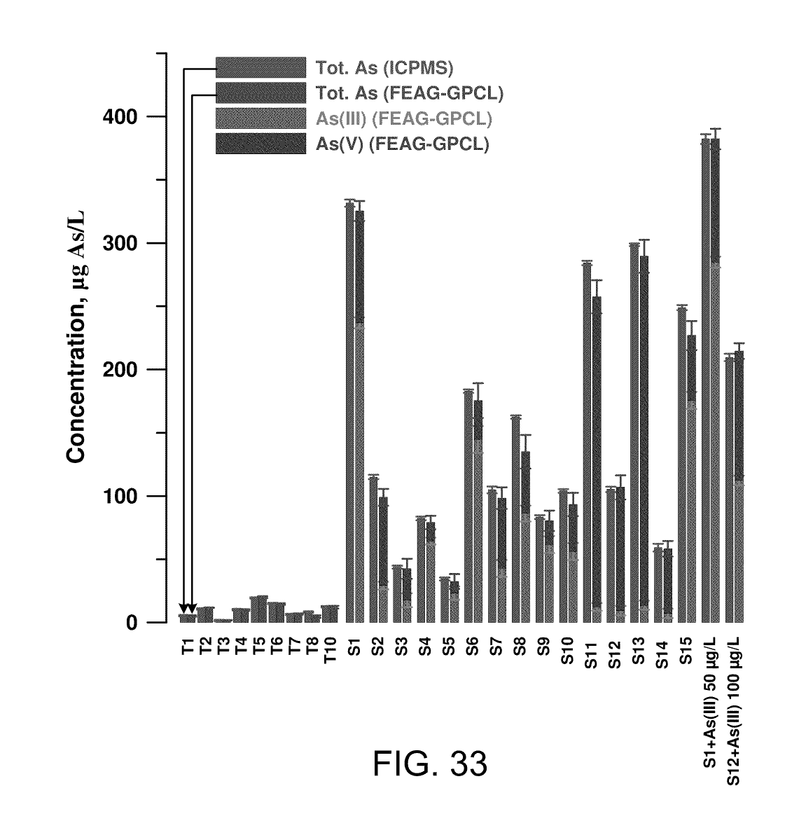

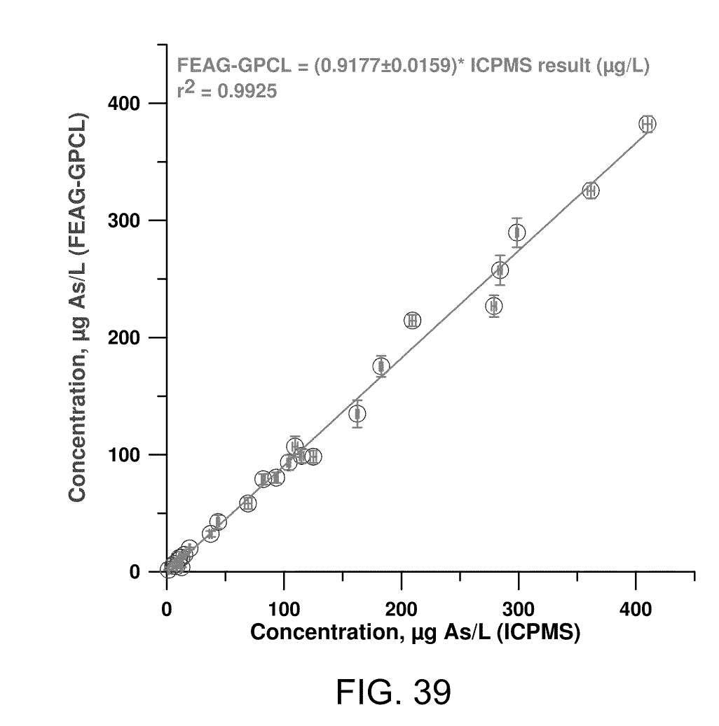

For the system validation and application in real sample analysis, we analyzed 9 tap water samples collected from different areas in Western Texas (not known for arsenic contamination) and 15 groundwater samples from arsenic contaminated areas in North-24 Pgs. and Murshidabad districts in West Bengal (WB)—India. The analyzed result with the current set-up was compared with ICP-MS measurement, which is known to be the standard technique for elemental analysis. The results for both the methods agree well as shown in FIG. 33, providing a very high correlation between them (r²=0.9925, slope 0.92, intercept statistically indistinguishable from zero, ICP-MS conditions described in M. K. Sengupta, P. K. Dasgupta, Anal. Chem. 2009, 81, 9737-9743; a plot is shown in FIG. 39). Inorganic As speciation was performed by measuring As(III) only in WB samples. West Texas samples were not considered for speciation as these tap water samples are pretreated with hypochlorite to disinfect bacteriological contamination, which in turn oxidizes any As species if present to arsenate. In order to validate As(III) results, known concentrations of As(III) were spiked to 2 water samples (S1 and S12) and the sum total As was compared with the ICP-MS result as shown in FIG. 33. The spiked recovery of As(III) was found to be over 95%, suggesting the capability of the system for measuring As(III) as total As sensitively and accurately under the described conditions.

In this example, stock standards of 100 mg As/L were prepared. Inorganic As(III) and As(V) were prepared in 1 mM HCl from As₂O₃ and Na₂HAₛO₄.7H₂O (both from J. T. Baker), respectively. Lower concentrations were prepared by dilutions with (18.2 MΩ 2 cm) Milli-Q deionized water (DIW). Different concentrations of electrolytes used for arsine generation were prepared from sulfuric acid (17.8 M, EMD Chemicals Inc.)

The electrochemical reactor (ECR) is the primary component of the continuous flow electrochemical arsine generation-gas phase chemiluminescence (CFEAG-GPCL) set-up. The ECR was constructed from a 0.254″ diameter, 1.0″ L graphite rod (Fine Detail, Fine Finish EDM Rod) as cathode. A central cavity of 0.094″ was drilled through the graphite rod where the anodic compartment sits. The anodic compartment comprised Pt wire (11.5 cm long, 0.25 mm dia.) as anode, housed inside a Nafion tube (1.27 mm OD, 1.05 mm ID, 8 cm long) that acted as an ionically electroconductive divider. PEEK tubes (3.18 mm OD, 35 mm long) were attached at both the end of the Nafion tube and extended out from both ends of the chamber. The tail end of the PEEK tube was sealed with a hot adhesive glue to prevent leakage and the upper end connected to a TEE (0409 TEEN, arkplas.com), where one arm containing the Pt wire was sealed, just exposing enough Pt wire for electric connection, while the second arm connected to the PP2, which drew the electrolyte-O₂ mixture at 1.4 mL/min to a reservoir vessel (RV), which acted as O₂ supply tank (vide infra) for the ozonizer. The entire anodic chamber was supported inside with a ferrule securing the Nafion-PEEK junction and further sealing the ends of the graphite cavity by threading with ¼×24 nuts. Two small holes (0.0625″) were drilled about the bottom and top part of the graphite rod and 2 stainless steel rods (0.18 cm OD×0.15 cm ID) were inserted in a way that did not block or physically contact the anodic chamber. These two lines acted as the electrolyte inlet (EI (bottom line)) and catholyte outlet (CO (top line)). A peristaltic pump (PP1), which supplied the electrolyte to the ECR at 3 mL/min, withdrew deionized water through one channel and caused it to flow through a six port injection valve and meet H₂SO₄ (0.05 M) supplied from a second channel of the same PP1 via a Tee, where it mixed in a 1:1 ratio and proceeded towards EI. Once the electrolyte entered the ECR, it was directed into 2 ways, one that flowed through the CO and the other that flowed from AO through the anodic chamber. In order for the electrolyte to flow inside the anodic chamber and to make the system electrically conductive, the Nafion tube was punctured (0.08 cm) at the bottom adjacent to the inlet line. The Pt wire and the stainless steel rods were connected to the +ye and −ye terminal of power supply (PS), respectively. The entire graphite chamber was finally coated with a graphite powder-epoxy mixture in order to prevent seepage of the electrolytic solution through the pores of the porous graphite chamber. The ECR schematic is shown in FIG. 7.

The OR included a simple gravity-based gas-liquid partitioning setup as discussed previously, and acted as an O₂ supply tank. The electrolyte-O₂ mixture generated at the anodic compartment flowed via PP2 to OR (2 L capacity, 75% pre-filled with 0.1 M H₂SO₄), where the liquid deposited at the bottom and the gaseous O₂ collected at the headspace of the OR and proceeded to the OZG as O₂ feed gas through a glass wool trap (GT) that removed any liquid droplets (see FIG. 7). Maintaining approximately the same liquid level throughout for uniform gas dispersion was done by creating waste outlet line (WO) at the rear bottom of the RV. PP2 withdrew the waste electrolyte from RV at 1.4 mL/min to a waste container (WC). The flow rate at steady state was ˜4 sccm, the same as that produced electrolytically, and was enough to supply sufficient ozone flow for the CL reaction.

In at least some embodiments, a gas-liquid separator should provide greater transport efficiency of the analyte, better reproducibility, and minimal dispersion, thereby facilitating an efficient and greater sensitivity. As this set-up is based upon gas-phase CL detection of arsenic, efficient transportation of arsine was considered. Three different designs of GLS, two gravity based separators and one micro-porous membrane based separator, were considered. The two gravity based GLS designs are shown in FIG. 9. For this current study, we fabricated GLS-PT from hydrophobic micro-porous membrane tube. This membrane provides excellent gas transmission through the membrane while restraining the liquid transport across the membrane. A 150 mm long, 2.3 mm OD, micro-porous tube (mPT) fitted inside a 5.1 mm OD×4.2 mm ID, PTFE tube worked as outer jacket (OJ). A stream of gas-liquid mixture entered the GLS-PT through gas-liquid inlet (GLI), where the liquid remained inside the mPT and exited out through the liquid outlet to waste, whereas the gaseous arsine and hydrogen escaped out from the pores of the mPT. The liberated gas collected at OJ proceeded toward the chemiluminescence chamber (CC) via a peristaltic pump (PP2) for getting detected.

All of the methods disclosed and claimed herein can be made and executed without undue experimentation in light of the present disclosure. While the apparatus and methods of this invention have been described in terms of preferred embodiments, it will be apparent to those of skill in the art that variations may be applied to the methods and in the steps or in the sequence of steps of the method described herein without departing from the concept, spirit and scope of the invention. For example, the method may include testing for either arsenic(III) or arsenic(V). The apparatus of FIG. 7 may be used, or the apparatus of FIG. 12 may be used to generate arsine for testing. In addition, modifications may be made to the disclosed apparatus and components may be eliminated or substituted for the components described herein where the same or similar results would be achieved. For example, various pumps may be configured to operate at different pump rates. As another example, some embodiments of the present systems include, and some embodiments of the present methods use, serially connected electrochemical reactors (such as those described above with reference to FIG. 2) such that arsine from which As(III) may be detected can be generated from a sample in the first ECR by applying current at a first level (e.g., 0.1 Amps) to an electrode (e.g., a graphite cathode) in contact with the sample (e.g., through an electrolyte), and passing effluent from the first ECR to a second ECR where the remaining arsenic that comprises both As(V) and As(III) that remained unreacted in the first ECR is determined, at least in part, by applying current at a second, higher level (e.g., 0.8 or 0.85 Amps) to an electrode (e.g., a graphite cathode) in contact with the sample. All such similar substitutes and modifications apparent to those skilled in the art are deemed to be within the spirit, scope, and concept of the invention as defined by the appended claims.

What is claimed is:

1. A method comprising:
detecting arsenic (III) by, at least in part, applying electrolytic current to an arsenic compound that has not been reduced with a reducing agent.

2. A method comprising:
detecting arsenic (V) by, at least in part, applying electrolytic current to an arsenic compound that has not been reduced with a reducing agent.

3. A method comprising:
generating arsine by, at least in part, applying current to a graphite cathode, the graphite cathode being in contact with an arsenic compound through an electrolyte.

4. The method of claim 3, wherein the arsenic compound is arsenic (III).

5. The method of claim 4, comprising applying 0.1 Amps of current to the graphite cathode to generate the arsine from arsenic (III).

5. The method of claim 3, wherein the target arsenic compound is arsenic (V).

6. The method of claim 5, comprising applying 0.8 Amps or 0.85 Amps of current to the graphite cathode to generate the arsine from both arsenic (III) and arsenic (V).

7. The method of claim 3, further comprising mixing the arsine with ozone gas.

8. The method of claim 7, further comprising detecting a level of chemiluminescence generated by a reaction between the arsine and the ozone gas.

9. The method of claim 3, wherein the electrolyte is sulfuric acid (H₂SO₄).

10. A method comprising:
detecting total arsenic in a sample by, at least in part, applying current at a first level to an electrode in contact with a first portion of the sample; and
detecting arsenic (III) in the sample by, at least in part, applying current at a second level to an electrode in contact with a second portion of the sample;
where the first level is greater than the second level.

11. A method comprising:
detecting total arsenic in a sample by, at least in part, applying current at a first level to an electrode in contact with a first portion of the sample; and
determining an amount of arsenic (V) in the sample using the total arsenic.

12. An apparatus comprising:
an electrochemical reactor that includes a graphite cathode;
a current source connected to the graphite cathode, the current source configured to deliver one of two different current levels to the graphite cathode; and
a driver configured to drive the current source at one of the two different current levels.

13. The apparatus of claim 12, comprising a chemiluminescence reaction chamber coupled to the electrochemical reactor.

14. The apparatus of claim 13, comprising a chemiluminescence detector coupled to the chemiluminescence reaction chamber, and configured to detect a chemiluminescence level caused by a reaction in the chemiluminescence reaction chamber.

15. The apparatus of claim 13, comprising an ozone generator coupled to the chemiluminescence reaction chamber and configured to supply ozone to the chemiluminescence reaction chamber for mixing with the arsine.

16. The apparatus of claim 15, where the ozone generator is coupled to the electrochemical reactor and configured to receive oxygen molecules generated during the electrochemical reaction.

17. The apparatus of claim 12, comprising a gas/liquid separator coupled to the electrochemical reactor and configured to separate arsine from a product of the electrochemical reactor.

18. The apparatus of claim 12, comprising an arsenic oxidation unit coupled to the electrochemical reactor, the arsenic oxidation unit configured to reduce total arsenic to arsenic (V).

19. The apparatus of claim 18, where the arsenic oxidation unit uses sodium hypochlorite (NaOCl) as an oxidizing agent to oxidize the total arsenic to arsenic (V) during use.

20. A method comprising:
detecting arsenic(III) in a sample by, at least in part, applying current at a first level to an electrode in contact with the sample in a first electrochemical reactor; and
passing effluent from the first electrochemical reactor into a second electrochemical reactor where an amount of remaining arsenic that comprises both arsenic(V) and any arsenic(III) that remained unreacted in the first electrochemical reactor is determined, at least in part, by applying current at a second level to an electrode in contact with the sample, the second level being higher than the first level.
